(19) United States
(12) Patent Application Publication
(10) Pub. No.: US 2024/0172223 A1
(43) Pub. Date: May 23, 2024

(54) DEFAULT BEAM CONFIGURATION SELECTION FOR UPLINK TRANSMISSIONS

(71) Applicant: QUALCOMM INCORPORATED, San Diego, CA (US)

(72) Inventors: Fang YUAN, Beijing (CN); Yan ZHOU, San Diego, CA (US); Sony AKKARAKARAN, Poway, CA (US); Tao LUO, San Diego, CA (US)

(21) Appl. No.: 18/548,327

(22) PCT Filed: Apr. 6, 2021
(86) PCT No.: PCT/CN2021/085547

§ 371 Date: Aug. 29, 2023

(51) Int. Cl. H04W 72/1268; H04W 16/28; H04W 72/02; H04W 72/044; H04W 72/232

(52) U.S. Cl. CPC H04W 72/1268; H04W 16/28; H04W 72/02; H04W 72/046; H04W 72/0466; H04W 72/232

(57) ABSTRACT

Methods, systems, and devices for wireless communications are described. Generally, a user equipment (UE) may receive downlink control information (DCI) from a base station, indicating a set of codepoints corresponding to a set of beam configurations, and including an uplink grant. The UE may select a codepoint from the set of codepoints corresponding to a default uplink beam for transmitting an uplink message based at least in part on a beam configuration selection criteria that indicates criteria for selecting a subset of valid beam configurations from the set of beam configurations. The UE may transmit the scheduled uplink message according to the uplink grant using the default uplink beam.

### CROSS REFERENCE

The present application is a 371 national stage filing of International PCT Application No. PCT/CN2021/085547 by YUAN et al. entitled “DEFAULT BEAM CONFIGURATION SELECTION FOR UPLINK TRANSMISSIONS,” filed Apr. 6, 2021, which is assigned to the assignee hereof, and which is expressly incorporated by reference in its entirety herein.

### FIELD OF TECHNOLOGY

The following relates to wireless communications, including default beam configuration selection for uplink transmissions.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

The described techniques relate to improved methods, systems, devices, and apparatuses that support default beam configuration selection for uplink transmissions. Generally, a user equipment (UE) may identify a default uplink beam (e.g., a default uplink transmission configuration indicator (TCI) state) for transmitting a scheduled uplink message based on codepoints of a TCI indication included in a downlink control information (DCI) message. A DCI message may include a TCI field, which may indicate a single TCI state or a pair of TCI states. Some of the indicated TCI states or pairs of TCI states may include an uplink beam (e.g., an uplink TCI state or a joint downlink/uplink TCI state). Thus, TCI state codepoints that include or indicate an uplink beam may be considered valid codepoints. The UE may determine which TCI state codepoints are valid based on a beam configuration (e.g., TCI state) selection criteria.

The beam configuration selection criteria may include one or more rules for which beam configurations or how many beam configurations are considered valid. In some examples, the beam configuration selection criteria may further include one or more rules for selecting or utilizing one or more valid TCI states of a set of valid TCI states. Of the various TCI state codepoints included in a TCI field, a subset of the codepoints may be considered valid codepoints (e.g., valid codepoints may indicate or include uplink beams). The UE may select a codepoint from a set of valid codepoints, and may use, as a default uplink beam for transmitting the scheduled uplink message, the uplink beam associated with the selected valid codepoint. In some examples, a single default beam may be considered valid based on a default TCI codepoint (e.g., pairs of TCI states may not be considered valid). In some examples, two default beams may be considered valid based on a default TCI codepoint indicating both beams (e.g., pairs of TCI states may be considered valid). In some examples, a scheduling DCI may not include one or more TCI state codepoints, and the UE may determine the default uplink beam based on a different DCI message (e.g., a most recently received DCI message) that satisfies one or more rules or conditions.

A method for wireless communications at a user equipment (UE) is described. The method may include receiving, from a base station, downlink control information including an uplink grant for a physical uplink shared channel, the downlink control information indicating a set of codepoints corresponding to a set of beam configurations, selecting a codepoint from the set of codepoints corresponding to a default uplink beam for transmitting an uplink message on the physical uplink shared channel based on a beam configuration selection criteria that indicates criteria for selecting a subset of valid beam configurations from the set of beam configurations, and transmitting the uplink message on the physical uplink shared channel in accordance with the uplink grant using the default uplink beam.

An apparatus for wireless communications at a UE is described. The apparatus may include a processor, memory coupled with the processor, and instructions stored in the memory. The instructions may be executable by the processor to cause the apparatus to receive, from a base station, downlink control information including an uplink grant for a physical uplink shared channel, the downlink control information indicating a set of codepoints corresponding to a set of beam configurations, select a codepoint from the set of codepoints corresponding to a default uplink beam for transmitting an uplink message on the physical uplink shared channel based on a beam configuration selection criteria that indicates criteria for selecting a subset of valid beam configurations from the set of beam configurations, and transmit the uplink message on the physical uplink shared channel in accordance with the uplink grant using the default uplink beam.

Another apparatus for wireless communications at a UE is described. The apparatus may include means for receiving, from a base station, downlink control information including an uplink grant for a physical uplink shared channel, the downlink control information indicating a set of codepoints corresponding to a set of beam configurations, means for selecting a codepoint from the set of codepoints corresponding to a default uplink beam for transmitting an uplink message on the physical uplink shared channel based on a beam configuration selection criteria that indicates criteria for selecting a subset of valid beam configurations from the set of beam configurations, and means for transmitting the uplink message on the physical uplink shared channel in accordance with the uplink grant using the default uplink beam.

A non-transitory computer-readable medium storing code for wireless communications at a UE is described. The code may include instructions executable by a processor to receive, from a base station, downlink control information including an uplink grant for a physical uplink shared channel, the downlink control information indicating a set of codepoints corresponding to a set of beam configurations, select a codepoint from the set of codepoints corresponding to a default uplink beam for transmitting an uplink message on the physical uplink shared channel based on a beam configuration selection criteria that indicates criteria for selecting a subset of valid beam configurations from the set of beam configurations, and transmit the uplink message on the physical uplink shared channel in accordance with the uplink grant using the default uplink beam.

Some examples of the method, apparatuses, and non-transitory computer-readable medium described herein may further include operations, features, means, or instructions for comparing codepoint identifiers for codepoints corresponding to the subset of valid beam configurations, where selecting the codepoint from the set of codepoints may be based on an ordering of the compared codepoint identifiers.

Some examples of the method, apparatuses, and non-transitory computer-readable medium described herein may further include operations, features, means, or instructions for selecting, based on the beam configuration selection criteria, the subset of valid beam configurations, where the beam configuration selection criteria includes a restriction of the subset of valid beam configurations to beam configurations having a single uplink beam option.

Some examples of the method, apparatuses, and non-transitory computer-readable medium described herein may further include operations, features, means, or instructions for selecting, based on the beam configuration selection criteria, the subset of valid beam configurations, where the beam configuration selection criteria includes a restriction of the subset of valid beam configurations to beam configurations having a single uplink beam option, multiple uplink beam options, or both.

Some examples of the method, apparatuses, and non-transitory computer-readable medium described herein may further include operations, features, means, or instructions for applying a rule indicated in the beam configuration selection criteria, the rule including an indication of which of the multiple uplink beam options to select for transmitting the uplink message, where selecting the codepoint from the set of codepoints may be based on applying the rule.

Some examples of the method, apparatuses, and non-transitory computer-readable medium described herein may further include operations, features, means, or instructions for selecting, based on the beam configuration selection criteria, a second codepoint from the set of codepoints corresponding to a second default uplink beam of the subset of valid beam configurations.

In some examples of the method, apparatuses, and non-transitory computer-readable medium described herein, transmitting the uplink message may include operations, features, means, or instructions for transmitting a first repetition of the uplink message using the default uplink beam and transmitting a second repetition of the uplink message using the second default uplink beam.

Some examples of the method, apparatuses, and non-transitory computer-readable medium described herein may further include operations, features, means, or instructions for receiving, in the downlink control information, a beam switching indication indicating which of the multiple uplink beam options to select for transmitting the uplink message, where selecting the codepoint from the set of codepoints may be based on receiving the beam switching indication.

In some examples of the method, apparatuses, and non-transitory computer-readable medium described herein, receiving the downlink control information may include operations, features, means, or instructions for receiving a first downlink control information message including the uplink grant for the physical uplink shared channel and receiving, prior to receiving the first downlink control information message, a second downlink control information message including the set of codepoints.

Some examples of the method, apparatuses, and non-transitory computer-readable medium described herein may further include operations, features, means, or instructions for comparing a first control resource set pool index associated with the first downlink control information message with a second control resource set pool index associated with the second downlink control information message and determining, based on the comparing, that the first control resource set pool index and the second control resource set pool index may be the same, where selecting the codepoint may be based on the first control resource set pool index and the second control resource set pool index being the same.

Some examples of the method, apparatuses, and non-transitory computer-readable medium described herein may further include operations, features, means, or instructions for determining that a time period between receiving the second downlink control information message and receiving the first downlink control information message satisfies a threshold timing gap, where selecting the codepoint may be based on the determining.

In some examples of the method, apparatuses, and non-transitory computer-readable medium described herein, at least one of the first downlink control information message or the second downlink control information message includes a group-common downlink control information message.

Some examples of the method, apparatuses, and non-transitory computer-readable medium described herein may further include operations, features, means, or instructions for receiving, from the base station, an indication of the threshold timing gap, where determining that the time period satisfies the threshold timing gap may be based on receiving the indication of the threshold timing gap.

Some examples of the method, apparatuses, and non-transitory computer-readable medium described herein may further include operations, features, means, or instructions for comparing a first time offset value with a second time offset value and selecting the first time offset value based on the comparing, where the first time offset value includes the threshold timing gap and where determining that the time period satisfies the threshold timing gap may be based on selecting the first time offset value.

Some examples of the method, apparatuses, and non-transitory computer-readable medium described herein may further include operations, features, means, or instructions for receiving, from the base station, an indication of the beam configuration selection criteria, where selecting the codepoint may be based on receiving the indication of the beam configuration selection criteria.

A method for wireless communications at a base station is described. The method may include transmitting, to a UE, a downlink control information including an uplink grant for a physical uplink shared channel, the downlink control information indicating a set of codepoints corresponding to a set of beam configurations, selecting a default uplink beam for receiving an uplink message on the physical uplink shared channel based on a beam configuration selection criteria that indicates criteria for selecting a subset of valid beam configurations from the set of beam configurations, and receiving the uplink message on the physical uplink shared channel in accordance with the uplink grant using the default uplink beam.

An apparatus for wireless communications at a base station is described. The apparatus may include a processor, memory coupled with the processor, and instructions stored in the memory. The instructions may be executable by the processor to cause the apparatus to transmit, to a UE, a downlink control information including an uplink grant for a physical uplink shared channel, the downlink control information indicating a set of codepoints corresponding to a set of beam configurations, select a default uplink beam for receiving an uplink message on the physical uplink shared channel based on a beam configuration selection criteria that indicates criteria for selecting a subset of valid beam configurations from the set of beam configurations, and receive the uplink message on the physical uplink shared channel in accordance with the uplink grant using the default uplink beam.

Another apparatus for wireless communications at a base station is described. The apparatus may include means for transmitting, to a UE, a downlink control information including an uplink grant for a physical uplink shared channel, the downlink control information indicating a set of codepoints corresponding to a set of beam configurations, means for selecting a default uplink beam for receiving an uplink message on the physical uplink shared channel based on a beam configuration selection criteria that indicates criteria for selecting a subset of valid beam configurations from the set of beam configurations, and means for receiving the uplink message on the physical uplink shared channel in accordance with the uplink grant using the default uplink beam.

A non-transitory computer-readable medium storing code for wireless communications at a base station is described. The code may include instructions executable by a processor to transmit, to a UE, a downlink control information including an uplink grant for a physical uplink shared channel, the downlink control information indicating a set of codepoints corresponding to a set of beam configurations, select a default uplink beam for receiving an uplink message on the physical uplink shared channel based on a beam configuration selection criteria that indicates criteria for selecting a subset of valid beam configurations from the set of beam configurations, and receive the uplink message on the physical uplink shared channel in accordance with the uplink grant using the default uplink beam.

In some examples of the method, apparatuses, and non-transitory computer-readable medium described herein, the beam configuration selection criteria includes a restriction of the subset of valid beam configurations to beam configurations having a single uplink beam option.

In some examples of the method, apparatuses, and non-transitory computer-readable medium described herein, the beam configuration selection criteria includes a restriction of the subset of valid beam configurations to beam configurations having a single uplink beam option, multiple uplink beam options, or both.

In some examples of the method, apparatuses, and non-transitory computer-readable medium described herein, receiving the uplink message may include operations, features, means, or instructions for receiving a first repetition of the uplink message using the default uplink beam associated with a first uplink beam option of the multiple uplink beam options and receiving a second repetition of the uplink message using a second default uplink beam associated with a second uplink beam option of the multiple uplink beam options.

In some examples of the method, apparatuses, and non-transitory computer-readable medium described herein, transmitting the downlink control information may include operations, features, means, or instructions for transmitting a first downlink control information message including the uplink grant for the physical uplink shared channel and transmitting, prior to transmitting the first downlink control information message, a second downlink control information message including a the set of codepoints.

Some examples of the method, apparatuses, and non-transitory computer-readable medium described herein may further include operations, features, means, or instructions for receiving the uplink message on the default uplink beam may be based on a first control resource set pool index associated with the first downlink control information message being the same as a second control resource set pool index associated with the second downlink control information message.

Some examples of the method, apparatuses, and non-transitory computer-readable medium described herein may further include operations, features, means, or instructions for receiving the uplink message on the default uplink beam may be based on a time period between transmitting the second downlink control information message and transmitting the first downlink control information message satisfies a threshold timing gap.

Some examples of the method, apparatuses, and non-transitory computer-readable medium described herein may further include operations, features, means, or instructions for transmitting, to the UE, an indication of the beam configuration selection criteria, where receiving the uplink message on the default uplink beam may be based on transmitting the indication of the beam configuration selection criteria.

### BRIEF DESCRIPTION OF THE DRAWINGS

FIG. 1 illustrates an example of a wireless communications system that supports default beam configuration selection for uplink transmissions in accordance with aspects of the present disclosure.

FIG. 2 illustrates an example of a wireless communications system that supports default beam configuration selection for uplink transmissions in accordance with aspects of the present disclosure.

FIG. 3 illustrates an example of a process flow that supports default beam configuration selection for uplink transmissions in accordance with aspects of the present disclosure.

FIG. 4 illustrates an example of a timeline that supports default beam configuration selection for uplink transmissions in accordance with aspects of the present disclosure.

FIG. 5 illustrates an example of a process flow that supports default beam configuration selection for uplink transmissions in accordance with aspects of the present disclosure.

FIGS. 6 and 7 show block diagrams of devices that support default beam configuration selection for uplink transmissions in accordance with aspects of the present disclosure.

FIG. 8 shows a block diagram of a communications manager that supports default beam configuration selection for uplink transmissions in accordance with aspects of the present disclosure.

FIG. 9 shows a diagram of a system including a device that supports default beam configuration selection for uplink transmissions in accordance with aspects of the present disclosure.

FIGS. 10 and 11 show block diagrams of devices that support default beam configuration selection for uplink transmissions in accordance with aspects of the present disclosure.

FIG. 12 shows a block diagram of a communications manager that supports default beam configuration selection for uplink transmissions in accordance with aspects of the present disclosure.

FIG. 13 shows a diagram of a system including a device that supports default beam configuration selection for uplink transmissions in accordance with aspects of the present disclosure.

FIGS. 14 through 17 show flowcharts illustrating methods that support default beam configuration selection for uplink transmissions in accordance with aspects of the present disclosure.

### DETAILED DESCRIPTION

Wireless communications systems may support communications via directional beams. In some examples, a base station may configure a user equipment (UE) with one or more transmission configuration indicator (TCI) states. The UE may use different active TCI states to generate uplink beams, receive downlink signaling on downlink beams, or any combination thereof. In some examples, the base station may schedule uplink transmissions, and may indicate uplink beams on which the UE is to send the uplink transmissions. However, in some examples, an uplink grant (e.g., included in a downlink control information (DCI) message) may not include an explicit indication of an uplink beam on which to send the uplink transmission.

In cases where an uplink beam is not explicitly indicated or is not available to the UE for a scheduled uplink transmission, the UE may select a default uplink beam (e.g., a default uplink TCI state). For instance, some wireless communications systems may support selection of a default uplink beam that matches a downlink beam on which a downlink reference signal is received (e.g., based on a quasi co-location (QCL) assumption for the CORESET that has the lowest identifier). That is, the UE 115 may select a default uplink beam for an uplink transmission that matches a downlink beam for a control resource set (CORESET) or a physical downlink shared channel (PDSCH).

However, in some examples, a downlink beam associated with the CORESET having the lowest identifier may not be associated with a matching uplink beam. Unified TCI states may be indicated in a DCI for multiple channels, but may not always include corresponding pairs of uplink and downlink beams. For example, a base station may configure only downlink beams for a particular CORESET, or may configure one or more downlink beams that do not have corresponding uplink beams. In such examples, a UE that attempts to select a default uplink TCI state with reference to a QCL assumption of a particular CORESET may not be able to identify an uplink TCI state (e.g., a QCL assumption of that CORESET may not correspond to any uplink TCI state). In such examples, the UE may have to determine or identify a new uplink TCI state and an uplink beam on which to transmit the scheduled uplink message. This may result in increased delays for the UE, or failed transmissions (e.g., if the UE does not identify an uplink beam on which to transmit the scheduled uplink message before the occurrence of the scheduled uplink resources on the PUSCH), or both. Such delays or failed transmissions may result in increased system latency, increased congestion, inefficient use of resources, and reduced user experience.

In some examples, a UE may identify a default uplink beam (e.g., default uplink TCI state) for transmitting an uplink message based on codepoints of a TCI indication included in downlink control signaling such as a DCI message. A base station may transmit a DCI message to the UE. The DCI message may include a TCI field, which may indicate a single TCI state or a pair of TCI states. Some of the indicated TCI states or pairs of TCI states may include an uplink beam (e.g., an uplink TCI state or a joint downlink/uplink TCI state). Thus, TCI state codepoints that include or indicate an uplink beam may be considered valid codepoints. For example, the TCI field in a received DCI message may include one or more TCI indications. The TCI indications may indicate one or more cases (e.g., a pair of TCI states or a single TCI state, or any combination thereof). Some of the indicated cases (e.g., single TCI states or joint TCI states or pairs of TCI states) may be considered valid cases (e.g., may indicate an uplink TCI state or a joint uplink/downlink TCI state on which the scheduled uplink transmissions may be sent). Some of the cases may be considered invalid cases (e.g., may only include a downlink TCI state or a pair of downlink TCI states). The UE may determine which cases are valid based on a beam configuration (e.g., TCI state) selection criteria.

The beam configuration selection criteria may include one or more rules for which beam configurations (e.g., cases) or how many beam configurations (e.g., cases) are considered valid. In some examples, the beam configuration selection criteria may further include one or more rules for selecting or utilizing one or more valid TCI states of a set of valid TCI states. In such examples, the UE may determine which of the cases indicated in the TCI field are valid (e.g., may eliminate one or more invalid cases), and may select a valid codepoint from a set of one or more valid codepoints. That is, of the various TCI state codepoints included in a TCI field, a subset of the codepoints may be considered valid codepoints (e.g., valid codepoints may indicate uplink beams). The UE may select a codepoint from a set of valid codepoints, and may use, as a default uplink beam, the uplink beam associated with the selected valid codepoint.

In some examples, a single default beam may be considered valid based on a default TCI codepoint (e.g., pairs of TCI states may not be considered valid). In some examples, two default beams may be considered valid based on a default TCI codepoint indicating both beams (e.g., pairs of TCI states may be considered valid). In some examples, a scheduling DCI may not include one or more TCI state codepoints, and the UE may determine the default uplink beam based on a different DCI message (e.g., a most recently received DCI message) that satisfies one or more rules or conditions.

Aspects of the disclosure are initially described in the context of wireless communications systems. Aspects of the disclosure are further illustrated by and described with reference to wireless communications systems, process flows, and timelines. Aspects of the disclosure are further illustrated by and described with reference to apparatus diagrams, system diagrams, and flowcharts that relate to default beam configuration selection for uplink transmissions.

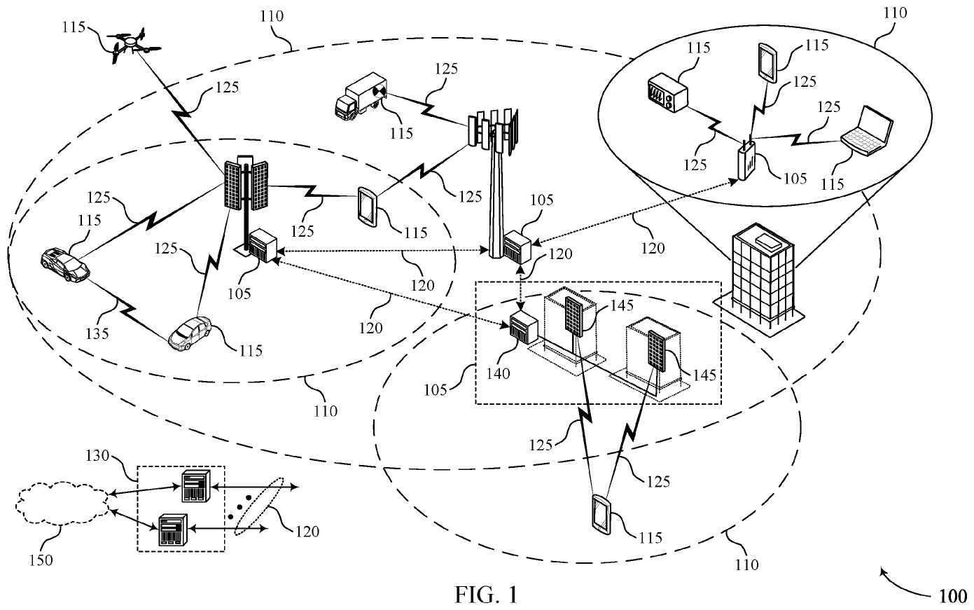

FIG. 1 illustrates an example of a wireless communications system 100 that supports default beam configuration selection for uplink transmissions in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

A UE 115 may identify a default uplink beam (e.g., a default uplink transmission configuration indicator (TCI) state) for transmitting a scheduled uplink message based on codepoints of a TCI indication included in a DCI message. A DCI message may include a TCI field, which may indicate a single TCI state or a pair of TCI states. Some of the indicated TCI states or pairs of TCI states may include an uplink beam (e.g., an uplink TCI state or a joint downlink/uplink TCI state). Thus, TCI state codepoints that include or indicate an uplink beam may be considered valid codepoints. The UE 115 may determine which TCI state codepoints are valid based on a beam configuration (e.g., TCI state) selection criteria.

The beam configuration selection criteria may include one or more rules for which beam configurations or how many beam configurations are considered valid. In some examples, the beam configuration selection criteria may further include one or more rules for selecting or utilizing one or more valid TCI states of a set of valid TCI states. Of the various TCI state codepoints included in a TCI field, a subset of the codepoints may be considered valid codepoints (e.g., valid codepoints may indicate uplink beams). The UE 115 may select a codepoint from a set of valid codepoints, and may use, as a default uplink beam for transmitting the scheduled uplink message, the uplink beam associated with the selected valid codepoint. In some examples, a single default beam may be considered valid based on a default TCI codepoint (e.g., pairs of TCI states may not be considered valid). In some examples, two default beams may be considered valid based on a default TCI codepoint indicating both beams (e.g., pairs of TCI states may be considered valid). In some examples, a scheduling DCI may not include one or more TCI state codepoints, and the UE 115 may determine the default uplink beam based on a different DCI message (e.g., a most recently received DCI message) that satisfies one or more rules or conditions.

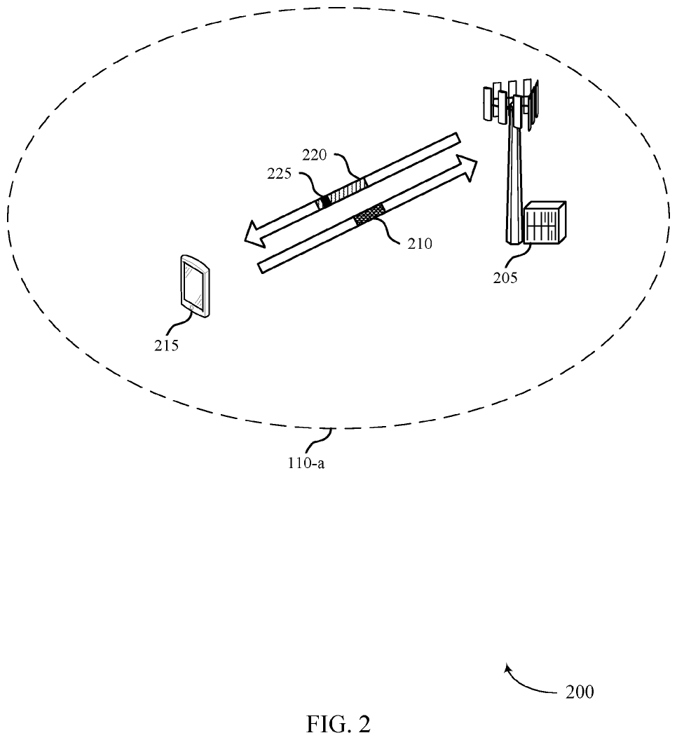

FIG. 2 illustrates an example of a wireless communications system 200 that supports default beam configuration selection for uplink transmissions in accordance with aspects of the present disclosure. The wireless communications system 200 may implement aspects of wireless communications system 100. For example, the wireless communications system 200 may include a base station 205 and a UE 215, which may represent examples of base stations 105 and UEs 115, respectively, as described with reference to FIG. 1. Additionally, the base station 205 and the UE 215 may support beamformed transmissions (e.g., beams used for the beamformed transmissions may correspond to different TCI states).

Some examples of a wireless communications system may support unified transmission configuration indicator (TCI) states. Higher-layer configurations may indicate one or more TCI states per control resource set (CORESET). In some examples, a unified TCI state may support M downlink TCI states and N uplink TCIs. For M=1 downlink TCI states, one or more reference signals (e.g., two reference signals if a type 2 QCL relationships has been configured in addition to a type 1 QCL relationship) in the downlink TCI state may provide QCL information at least for UE-dedicated reception on a PDSCH and all of CORESTs in a component carrier (CC). For N=1 uplink TCI states, a source reference signal in the uplink TCI state may provide a reference for determining uplink transmission spatial filters at least for dynamic grants or configured grants based on PUSCH and all of dedicated PUCCH resources in a CC. For N=M=1, a joint uplink/downlink TCI state may be configured. In such examples, a TCI state may refer to at least a common source reference signal used for determining both the downlink QCL information and the uplink transmission spatial filter. In cases of a separate downlink/uplink TCI state, a downlink TCI state and an uplink TCI state may be distinct (e.g., separate).

For M>1 downlink TCI states, each of the M source reference signals (or 2×M if type 2 QCL relationship is configured in addition to type 1 QCL relationship) in the M downlink TCI states may provide QCL information at least for one of the M beam pair links for UE-dedicated reception on a PDSCH or a subset of CORESETs in a CC. For N>1 uplink TCI states, each of the N source reference signals in the N uplink TCI states may provide a reference for determining uplink transmission spatial filters at least for one of the N beam pair links associated with dynamic grants or configured grant based PUSCH resources in a CC. For M>1 or N>1 or both joint downlink/uplink TCI states, a TCI state may refer to at least a common source reference signal used for determining both the downlink QCL information and the uplink transmission spatial filter. In such examples, M may equal N. In the case of separate downlink/uplink TCI states, M downlink TCI states and N uplink TCI states are distinct (e.g., separate).

Unified TCI states may therefore be defined by one or more types. Type 1 TCI states may include a joint downlink/uplink common TCI state to indicate a common beam for at least one downlink channel and reference signal plus at least one uplink channel and reference signal. Type 2 TCI states may include separate downlink common TCI state to indicate a common beam for at least two downlink channels and reference signals. Type 3 TCI states may include a separate uplink common TCI state to indicate a common beam for at least two uplink channels and reference signals. Type 4 TCI states may include a separate downlink single channel and reference signal and TCI state to indicate a beam for a single downlink channel and reference signal. Type 5 TCI states may include a separate uplink single channel and reference signal and TCI state to indicate a beam for a single uplink channel and reference signal.

In some examples of unified TCI frameworks, a UE 115 may select, modify or down-select a TCI state configuration, or may be configured with one or more TCI states. For example, a base station may dynamically indicate either a joint downlink uplink TCI or separate downlink/uplink TCI states. UEs 115 may advertise its capability for the support of joint downlink/uplink TCI states or separate downlink uplink TCI states. In some examples, a UE 115 may be configured with either joint downlink uplink TCI states or separate downlink uplink TCI states via RRC signaling. A UE 115 may be configured with either joint downlink/uplink TCI states, separate downlink/uplink TCI states, or both, via RRC signaling. In some examples, a UE 115 may be configured with either joint downlink/uplink TCI states or separate downlink/uplink TCI states via MAC-CE signaling. One or more TCI states may be activated by a base station or other wireless device.

Wireless communications system 200 may support beam indication signaling to support joint or separate downlink/uplink beam indications in a unified TCI framework. In some examples, L1-based beam indications using at least UE-specific (e.g., unicast) DCI messages to indicate joint or separate downlink/uplink beam indications from active TCI states. In some examples, DCI messages for beam indication may be DCI format 1_1, or DCI format 1_2. UEs 115 may support mechanisms for acknowledging successful decoding of beam indications. For example, an acknowledgement (ACK) message or a negative acknowledgement (NACK) message of a PDSCH scheduled by the DCI carrying the beam indication may be used as an ACK or NACK message for the received DCI.

In some examples, a DCI message (e.g., DCI format 0_0) for a cell may include a grant but may not include an indication of an uplink beam on which to transmit a scheduled uplink transmission. The UE may transmit a scheduled uplink transmission on a default uplink beam. For example, if one or more higher layer parameters (e.g., enableDefaultBeamPL-ForPUSCHO-r16) are enabled, and if a receiving UE 115 is not configured with PUCCH resources on an active uplink BWP, and the UE 115 is operating in an RRC connected mode, the UE 115 may transmit an uplink message on a PUSCH according to a spatial relationship (e.g., if applicable) with reference to a reference signal (e.g., on a downlink beam) with a QCL type D relationship corresponding to the QCL assumption of the CORESET with the lowest identifier on an active downlink BWP of the cell. That is, in the case where the UE 115 is not configured with an uplink beam on which to transmit the scheduled uplink transmissions (e.g., if the UE is not configured with an uplink TCI state with which to transmit the scheduled uplink message), then the UE may identify a default uplink beam based on the CORESET IDs (e.g., may determine an uplink or joint uplink/downlink TCI state associated with the CORESET having the lowest ID).

Similarly, a PUSCH may be scheduled by a DCI (e.g., DCI format 0_0) on a cell. If one or more higher layer parameters (e.g., enableDefaultBeamPL-ForPUSCHO-r16) is set to enabled, a UE 115 that is configured with PUCCH resources on an active uplink BWP where all PUCCH resources are not configured with any spatial relation and the UE 115 is in an RRC connected mode, a UE 115 may transmit a message on the PUSCH according to the spatial relationship (e.g., if applicable), with reference to the reference signal with QCL type D corresponding to a QCL assumption of the CORESET with the lowest identifier on an active downlink BWP of the cell in case coresets are configured on the cell.

Thus, in cases where an uplink TCI state is not explicitly indicated or is not available to the UE 115 for a scheduled uplink transmission on a PUSCH, the UE may select a default uplink beam (e.g., a default uplink TCI state) that matches a downlink beam on which a downlink reference signal is received based on a QCL assumption for the CORESET having the lowest identifier. That is, the UE 115 may select a default uplink beam for a PUSCH that matches a downlink beam for a CORESET or a PDSCH.

However, in some examples, a downlink beam associated with the CORESET having the lowest identifier may not be associated with a matching uplink beam. Unified TCI states may be indicated in a DCI for multiple channels, but may not always include corresponding pairs of uplink and downlink beams. For example, a base station may configure only downlink beams for a particular CORESET, or may configure one or more downlink beams that do not have corresponding uplink beams. In such examples, a UE 115 that attempts to select a default uplink TCI state with reference to a QCL assumption of a particular CORESET may not be able to identify an uplink TCI state (e.g., a QCL assumption of that CORESET may not correspond to any uplink TCI state). In such examples, the UE 115 may have to determine or identify a new uplink TCI state and an uplink beam on which to transmit the scheduled uplink message. This may result in increased delays for the UE 115 (e.g., based on a beamforming or beam refinement procedure or a re-establishment procedure) or failed transmissions (e.g., if the UE does not identify an uplink beam on which to transmit the scheduled uplink message before the occurrence of the scheduled uplink resources on the PUSCH). Such delays or failed transmissions may result in increased system latency, increased congestion, inefficient use of resources, and reduced user experience.

Techniques described herein may support identifying a default uplink beam (e.g., default uplink TCI state) for transmitting the uplink message 210 based on codepoints of a TCI indication included in a DCI message 220 (e.g., instead of identifying a default uplink beam for transmitting an uplink message 210 on a PUSCH based on a CORESET identifier). Base station 205 may transmit DCI message 220 to UE 215. DCI message 220 may include a TCI field 225. The TCI field 225 may indicate a single TCI state or a pair of TCI states of multiple TCI state types. For example, a pair of TCI states may include a downlink TCI state and an uplink TCI state (e.g., which may be referred to as case 1). A pair of TCI states may include two uplink TCI states (e.g., which may be referred to as case 2). A pair of TCI states may include two joint downlink/uplink TCI states (e.g., which may be referred to as case 3). The TCI field in the DCI message may indicate a single TCI state. For example, a single TCI state may include a single joint downlink uplink TCI state (e.g., which may be referred to as case 4). A single TCI state may include a single uplink TCI state (e.g., which may be referred to as case 5). A MAC-CE may be used to activate a single TCI state or a pair of TCI states for the TCI field 225 in the DCI message 220.

A UE 115 may select a default uplink beam (e.g., a default uplink TCI state for generating a default uplink beam) based on a codepoint associated with a valid TCI type, as described herein. For example, the TCI field 225 may include one or more TCI indications. The TCI indications may indicate one or more cases (e.g., a pair of TCI states or a single TCI state, or any combination thereof). Some of the indicated cases (e.g., single TCI states or joint TCI states or pairs of TCI states) may be considered valid cases (e.g., may indicate an uplink TCI state or a joint uplink/downlink TCI state on which the scheduled uplink transmissions may be sent). Some of the cases may be considered invalid cases (e.g., may only include a downlink TCI state or a pair of downlink TCI states). The UE 215 may determine which cases are valid based on a beam configuration (e.g., TCI state) selection criteria. The beam configuration selection criteria may include one or more rules for which beam configurations (e.g., cases) or how many beam configurations (e.g., cases) are considered valid. In some examples, the beam configuration selection criteria may further include one or more rules for selecting or utilizing one or more valid TCI states of a set of valid TCI states. In such examples, the UE 115 may determine which of the cases indicated in the TCI field are valid (e.g., may eliminate one or more invalid cases), and may select a default uplink TCI state for transmitting an uplink message on the PUSCH from the valid TCI states. That is, of the various TCI state codepoint included in a TCI field 225, a subset of the codepoint may be considered valid codepoints (e.g., valid codepoint may indicate uplink beams). The UE may select a codepoint from a set of valid codepoints, and may use, as a default uplink beam, the uplink beam associated with the selected valid codepoint. Techniques described herein may apply to scenarios in which base station 205 schedules UE 215 for transmitting uplink message 210 within an explicit indication of a beam (e.g. DCI message 220 is a fall back DCI 0_0, and does not include a beam indication).

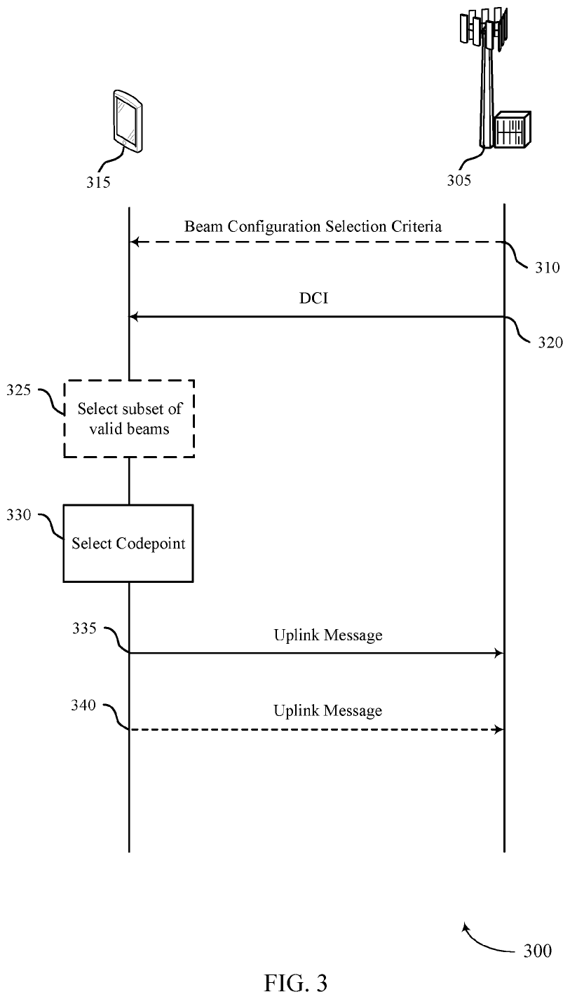

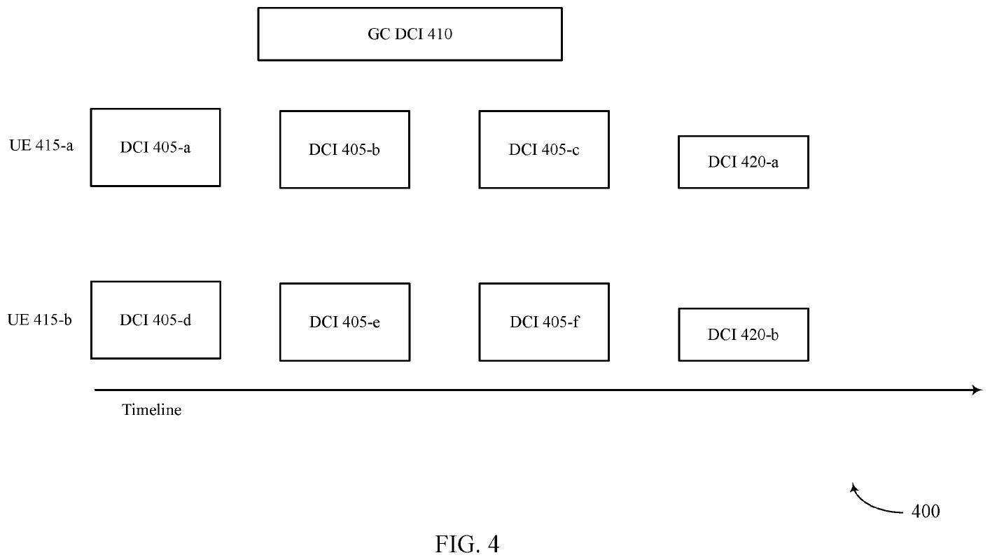

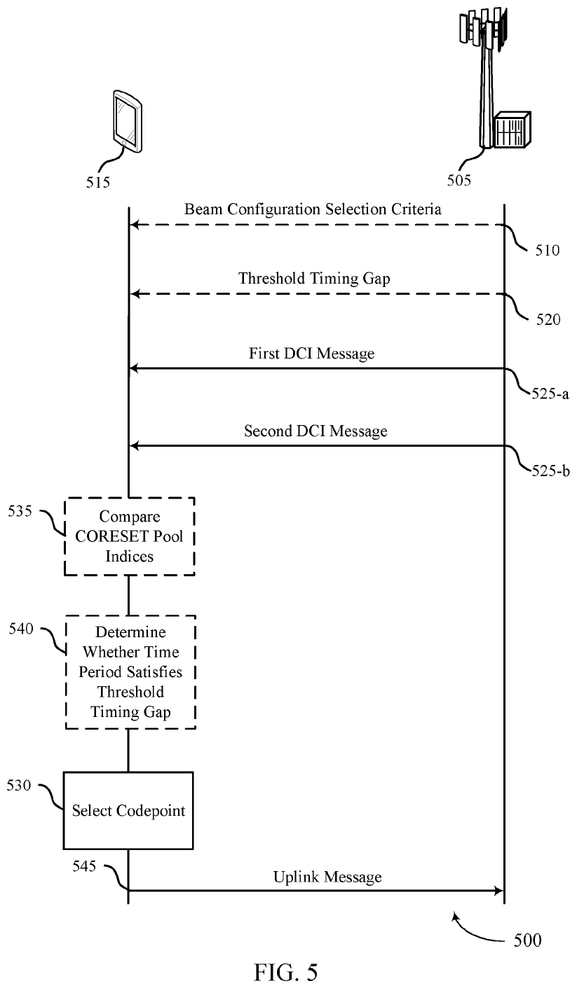

In some examples, a single default beam may be considered valid based on a default TCI codepoint (e.g., pairs of TCI states may not be considered valid), as described in greater detail with reference to FIG. 3. In some examples, two default beams may be considered valid based on a default TCI codepoint indicating both beams (e.g., pairs of TCI states may be considered valid), as described in greater detail with reference to FIG. 3. In some examples, the UE 215 may determine the default uplink beam based on a valid DCI message (e.g., a most recent DCI message 220) that satisfies one or more rules or conditions, as described in greater detail with reference to FIGS. 4-5.

FIG. 3 illustrates an example of a process flow 300 that supports default beam configuration selection for uplink transmissions in accordance with aspects of the present disclosure. Process flow 300 may include a base station 305 and a UE 315, which may be examples of corresponding devices described with reference to FIGS. 1-2.

At 320, base station 305 may transmit DCI to UE 315. The DCI may include an uplink grant (e.g., for transmitting an uplink message at 335) for a PUSCH. In some examples, the DCI may include a set of TCI state codepoints corresponding to a set of beam configurations (e.g., a TCI field 225 indicating one or more TCI states for one or more cases, as described with reference to FIG. 2). A DCI message may include both the uplink grant for the PUSCH and the set of one or more codepoints. In some examples, a first DCI message may include the uplink grant, but may not include the set of one or more codepoints (e.g., as illustrated and described with reference to FIGS. 4 and 5). In such examples, other DCI messages may include one or more TCI state codepoints.

At 330, UE 315 may select a TCI state codepoint from the set of TCI state codepoints. The selected codepoint may correspond to a default uplink beam for transmitting an uplink message at 335. UE 315 may select the codepoint based at least in part on a beam configuration selection criteria for selecting a subset of valid beam configurations (e.g. valid cases) from the set of beam configurations, as described herein.

At 335, UE 315 may transmit the uplink message to base station 305 on the PUSCH in accordance with the grant received in the DCI at 320, and using the default uplink beam (e.g., the uplink beam corresponding to the codepoint selected at 330).

In some examples, UE 315 may select the codepoint based on codepoint identifiers. For example, UE 315 may select, at 325, a subset of valid beam configurations from the full set of beam configurations. That is, UE 315 may select a valid codepoint from the set of one or more codepoints configured in the DCI message. UE 315 may determine that uplink beams associated with the valid codepoints are a subset of valid beam configurations of the set of beam configurations. Valid beam configurations may satisfy the beam configuration selection criteria. In some examples, multiple beam configurations may be valid. That is, multiple codepoints of the set of codepoints may correspond to uplink TCI states. In such examples, UE 315 may select one of the multiple codepoints based on comparing codepoint identifiers for codepoints corresponding to the subset of valid beam configurations. Based on the ordering of the codepoint identifiers, UE 315 may select the codepoint at 330. For instance, UE 315 may select the valid codepoint that has the highest, or the lowest, identifier.

In some examples, the beam selection criteria may include a restriction of the subset of valid beam configurations to beam configurations having a single uplink beam option. For example, The DCI at 320 may schedule transmission of the uplink message, but may not include a beam indication (e.g., may be a fall back DCI 0_0). For example, UE 315 may select the codepoint with the lowest identifier, the highest identifier, a middle median identifier, or the like. In such examples, UE 315 may apply a default beam to the uplink transmission with reference to the spatial filter of a unified TCI state on the active BWP of the cell, and the unified TCI state may be determined by a TCI codepoint having the lowest or highest identifier that includes a valid TCI state. A single default beam may be selected based on a default TCI codepoint. Only a single TCI state may be considered valid under the restrictions of the beam configuration selection criteria.

In some examples, valid TCI states may include only a single TCI state. A single TCI state may refer to only uplink TCI states (e.g., only case 5 is considered valid). A single TCI state may refer to only a joint downlink uplink TCI state (e.g., only case 4 is considered valid). A single T CI state may refer to an uplink TCI state or a joint downlink/uplink TCI state (e.g., both cases 5 and 4 are considered valid). In some examples, either a single TCI state or a pair of a downlink TCI state and an uplink TCI state may be considered valid (e.g., case 1 may be considered valid).

Thus, in cases where the beam configuration selection criteria restricts the subset of valid beam configurations to beam configurations having a single uplink beam option, UE 315 may determine which, if any, of the set of codepoints indicated in the DCI are valid. UE 315 may only consider codepoints valid if they satisfy the beam configuration selection criteria. For example, one or more DCI messages may include codepoints indicating one or more cases. For instance, codepoint 1 may indicate case 1, codepoint 2 may indicate case 4, and codepoint 3 may indicate case 5. In some examples, the beam configuration selection criteria may restrict valid beam configurations (e.g., valid codepoints associated with uplink TCI states) to a single uplink beam, such as only uplink TCI states (e.g., case 5). In such examples, the UE 315 may determine that codepoint 1 and codepoint 2 are both invalid, and may determine that codepoint 3 is valid. In such examples, UE 315 may select a codepoint (e.g., codepoint 3) at 330, and may thereby select a default uplink beam associated with the selected codepoint. UE 315 may then transmit the uplink message at 335 using the selected default uplink beam. Similarly, the single valid TCI state refers to an uplink TCI state or a joint downlink/uplink TCI state (e.g., both cases 5 and 4 are considered valid). In such examples, at 325, UE 315 may determine that both codepoint 2 and codepoint 3 are valid. At 330, UE 315 may select one of the valid subset of beams (e.g., may select both codepoints 2 and 3 as valid and codepoint 1 as invalid). For example, UE 315 may determine which of codepoint 2 and codepoint 3 has the lowest or highest identifier.

In some examples, the single valid TCI state may refer to a single uplink beam, such as only uplink TCI states (e.g., case 5). Codepoint 1 in the TCI field of the DCI may map to case 5, codepoint 2 in the TCI field may map to case 5, and codepoint 3 in DCI field may map to case 5. UE 315 may determine that any of the codepoints satisfies the beam configuration selection criteria, and may select (e.g., at 325) one of the valid codepoints based on the ordering of the identifiers. In some examples, UE 315 may select the subset of valid beams based on a set of one or more codepoints included in a single DCI message. In some examples, UE 315 may select the subset of valid beams based on a set of one or more codepoints included in multiple DCI messages, as illustrated with reference to FIG. 4. For example, the DCI message including the grant may not include any codepoints, or may not include any valid codepoints. In such examples, UE 315 may identify one or more valid codepoints in a previous DCI message, as described in greater detail with reference to FIGS. 4-5.

In some examples, the beam selection criteria may include a restriction of the subset of valid beam configurations to beam configurations having a single uplink beam option, multiple uplink beam options, or both. That is, UE 315 may select a valid codepoint, and two default beams may be associated with the default TCI codepoint. For example, the DCI received at 320 may schedule UE 315 with an uplink transmission, and the DCI message including the grant may not include any beam indication (e.g., the DCI message may be a fall back DCI 0_0). UE 315 may apply a default beam to the uplink transmission with a reference to a spatial transmit filter of a unified TCI state on the active BWP of the cell. The unified TCI state may be in a TCI codepoint having a lowest or highest identifier of a pair of TCI states. The pair of TCI states may include at least an uplink TCI state (e.g., case 1 and case 2 may be considered valid). The pair of TCI states may include at least one joint downlink/uplink TCI state (e.g., case 3 may be considered valid). The pair of TCI states may include at least one joint downlink/uplink TCI state, or one uplink TCI state (e.g., case 1, case 2, and case 3 may be considered valid).

Thus, based on the restrictions of the beam configuration selection criteria (e.g., supporting two default beams associated with a default TCI codepoint), UE 315 may select a codepoint associated with two TCI states. For example, a DCI message (e.g., a current DCI message including the uplink grant, or a previous DCI message, or any combination thereof) may include one or more codepoints. Codepoint 1 may be mapped to case 2, codepoint 2 may be mapped to case 5, and codepoint 3 may be mapped to case 5. In such examples, at 325, UE 315 may select codepoint 1 as a valid codepoint, and determine that codepoint 2 and codepoint 3 are not valid codepoint. Thus, UE 315 may select an uplink beam or a pair of uplink beams associated with codepoint 1 (e.g., case 2), as a subset of valid beams (e.g., and determine that uplink beams associated with codepoint 2 and codepoint 3 are not associated with valid uplink beams). At 330, UE 315 may select a valid codepoint from the set of valid codepoints (e.g., may select codepoint 1, which may be the only valid codepoint in such examples).

In some examples, the selected codepoint may include a pair of valid uplink beams. For example, the selected codepoint may indicate two uplink TCI states or two joint downlink/uplink TCI states. In such examples, UE 315 may determine which of the two uplink beams associated with the two uplink TCI states to use, or may use both TCI states for repetition. For example, UE 315 may determine which uplink beam to use based on a predetermined rule. Such a predetermined rule may be included in the beam configuration selection criteria, indicated in a downlink message (e.g., higher layer signaling, a DCI message, or the like), included in one or more standards, or any combination thereof. For example, the rules may indicate that UE 315 is to select, from the two uplink beams associated with the selected codepoint, the uplink beam that is first or has a lower or higher identifier of the pair of uplink beams. In some examples, UE 315 may use both of the uplink beams associated with the selected codepoint for uplink repetitions. For example, UE 315 may determine the uplink transmission to be transmitted with pane/beam repetition. In such examples, UE 315 may transmit a first repetition of the uplink message at 335 using the first beam, and may transmit a second repetition of the uplink message at 340 using the second beam. In some examples, base station 305 may explicitly indicate which of two valid beams to use for transmitting the uplink message at 335. For example, UE 315 may determine one uplink transmission to be transmitted with beam or beams selected by the uplink DCI message (e.g., that includes the uplink grant or the set of codepoints or both). For instance, a DCI message scheduling the uplink transmission may include a dedicated field that can be applied for dynamic panel switching or beam switching. The field may include an indication of which of two valid beams UE 315 is instructed to use for transmitting the scheduled uplink message.

In some examples, base station 305 may indicate the beam configuration selection criteria to UE 315 (e.g., at 310). The beam configuration selection criteria may be included in a DCI message, a higher layer signal message (e.g., an RRC information element (IE), a MAC-CE, or the like). The beam configuration selection criteria may be preconfigured at UE 315, included in one or more standards documents, or the like.

In some examples, any of the beam selection procedures described with reference to FIG. 3 may be utilized for selecting a valid codepoint from a DCI message that includes the uplink grant, or from previous DCI messages, as described with reference to FIGS. 4 and 5.

FIG. 4 illustrates an example of a timeline 400 that supports default beam configuration selection for uplink transmissions in accordance with aspects of the present disclosure. Timeline 400 may implement, or may be implemented by, one or more UEs 415, and one or more base stations, which may be examples of corresponding devices described with reference to FIGS. 1-3.

A base station may schedule one or more uplink transmissions from a UE 415 may transmitting one or more DCI messages. In some examples, DCI messages may be unicast DCI messages (e.g., DCIs 405 UE 415-a and UE 415-b). In some examples, a DCI message may be a group-common (GC) DCI 410, addressed to multiple UEs (e.g., both the first UE and the second UE). Some DCIs 405 or GC DCIs 410 may include a TCI field, which may include one or more codepoints indicating TCI states. For example, a TCI field in DCI 405-a may indicate codepoint 2, a TCI field in DCI 405-b may indicate codepoint 3, a TCI field in DCI 405-a may indicate codepoint 1, or the like. Similarly, a TCI field in DCI 405-d may indicate codepoint 2, a TCI field in DCI 405-e may indicate codepoint 3, a TCI field in DCI 405-f may indicate codepoint 1, or any other codepoints. GC DCI 410 may or may not include one or more codepoints for various UEs.

In some examples, a UE 415 may determine a default beam based on a most recently received DCI message that satisfies one or more rules. Such rules may be included in the beam configuration selection criteria, or may be separately configured, standardized, or otherwise know to the UE. A base station may configure the UE with an uplink transmission by a DCI 420. The DCI 420 may include a grant for the uplink message, may not include one or more codepoints or a beam indication. In such examples, the UE may apply a default beam to the uplink transmission with a reference to a spatial transmit filter of a unified TCI state indicated by a most recent DCI configured with a unified TCI codepoint. However, to be considered as the most recent DCI, the DCI may satisfy one or more rules.

UE 415-a may determine a most recent DCI on which to rely for determining the default uplink beam based on the CORESET identifiers of the different DCIs. For example, a most recent DCI may be transmitted in a CORESET of the same CORESET pool index as the DCI 420. If DCI 405-a is transmitted in a CORESET that has the same identifier as the CORESET on which DCI 420 is transmitted, then UE 415-a may determine that DCI 405-c is the most recent DCI 405, and may determine whether one or more codepoints (e.g., codepoint 1) are considered valid based on the beam configuration selection criteria. If so, UE 415-a may select codepoint 1 as a valid codepoint, and may transmit the uplink message granted in DCI 420-a using an uplink beam associated with codepoint 1. Or, UE 415-a may determine that codepoint 1 is not a valid codepoint, and may select a previously received DCI 405. If DCI 405-b is not received on the same CORESET as DCI 420-a, then UE 415-a may also not rely on the codepoint indicated in DCI 405-b (e.g., codepoint 3) for selecting the default uplink beam. If DCI 405-a indicates a codepoint that is considered a valid codepoint (e.g., codepoint 2) and is received on the same CORESET as DCI 420-a, then UE 415 may select the uplink beam associated with codepoint 2 as the default uplink beam.

UE 415-a may determine a most recent DCI based on a timing of the previous DCIs 405. For example, the most recent DCI may be a GC DCI 410. GC DCI 410 may indicated unified TCI states to more than one panel (e.g., and more than one UE 415). For instance, the DCI format of GC DCI 410 may be a DCI 2-x. In such examples, a minimum timing gap may be defined to determine which DCI is a most recent DCI. A minimum timing gap may also be referred to as a beam application time, a threshold timing gap, a threshold time duration, or the like. For GC DCI 410, the threshold timing gap may be defined by a new parameter (e.g., a higher layer parameter configurable by RRC or an updated MAC-CE or an updated DCI message). In some examples, the scheduling DCI (e.g., DCI 420-a) may include an indication of the threshold timing gap. The threshold timing gap may be included in the beam configuration selection criteria, included in a standard, or the like. In some examples, the threshold timing gap value may be derived from an existing timing offset. For example, UE 415-a may select one (e.g., a maximum) of two existing timing offsets of timing values. For instance, UE 415-a may select the maximum of two minimum timing offsets or processing offset (e.g., KO, which may refer to an offset between a PDCCH and a PDSCH, and K2, which may refer to a time offset between PDCCH and PUSCH), or may select the maximum of a time duration for QCL (e.g., timeDurationForQCL which may be defined as a minimum time offset required for TCI in DCI to take affect in the case of a single downlink TCI) and a timing offset (e.g., the maximum of timeDurationForQCL and K2), or the like.

Having determined a threshold timing gap, UE 415-a may determine whether GC DCI 410 satisfies the threshold timing gap. That is, a most recent DCI may be a DCI received before the beam application time (e.g., threshold timing gap) expires prior to receiving DCI 420-a (e.g., excluding DCIs 405 to which the beam indication has not yet been applied). UE 415-a may determine whether UE 415-a received GC DCI 410 at least the threshold timing gap prior to having received DCI 420-a. If such is the case, then UE 415-a may proceed to determine whether codepoints included in GC DCI 410 satisfy the beam configuration selection criteria. If so, UE 415-a may select a valid uplink beam associated with a valid codepoint indicated in GC DCI 410, as described with reference to FIG. 3. That is, a most recent DCI may be a DCI containing applicable TCI states (e.g., valid TCI states) as described in greater detail with reference to FIG. 3.

A GC DCI 410 may include the uplink grant, but may not include any codepoints or any valid codepoints. In such examples, UE 415-a (e.g., or UE 415-b) may determine which, if any, previously received DCI 405 may be considered a most recent DCI. For example, UE 415-a may determine whether DCI 405-a satisfies the threshold timing gap prior to receiving GC DCI 410, whether DCI 405-a was received in the same CORESET as GC DCI 410, whether DCI 405-a indicates a valid codepoint as described with reference to FIG. 3, or any combination thereof.

FIG. 5 illustrates an example of a process flow 500 that supports default beam configuration selection for uplink transmissions in accordance with aspects of the present disclosure. Process flow 500 may include a base station 505 and a UE 515, which may be examples of corresponding devices described with reference to FIGS. 1-4.

At 525, base station 505 may transmit DCI to UE 515. The DCI may include an uplink grant (e.g., for transmitting an uplink message at 335) for a PUSCH. Base station 505 may transmit a first DCI message at 525-a and a second DCI message at 525-b. The first DCI message may include a set of one or more codepoints corresponding to a set of beam configurations (e.g., a TCI field 225 indicating one or more TCI states for one or more cases, as described with reference to FIG. 2). In some examples, the second DCI message may include both the uplink grant for the PUSCH. In some examples, the second DCI message may not include an indication of an uplink beam. In such examples, UE 515 may determine a default uplink beam on which to transmit the message, as described with reference to FIG. 4.

To identify a default uplink beam, UE 515 may identify a default codepoint from the set of codepoints. However, to identify the set of codepoints, UE 515 may determine which previously transmitted DCI message (e.g., first DCI message) can be considered a most recent DCI.

In some examples, UE 515 may determine that the first DCI message is a most recent DCI message (e.g., and may rely on the set of codepoints indicated in the first DCI message to determine the default uplink beam) based on the CORESET pool indices of the two DCI messages. For example, UE 515 may compare the CORESET pool index of the CORESET on which base station 505 transmitted the first DCI message with the CORESET pool index of the CORESET on which base station 505 transmitted the second DCI message. UE 515 may determine that the first CORESET pool index is the same as the second CORESET pool index, and may therefore determine that the first DCI message is a most recent DCI message that satisfies one or more rules (e.g., included in the beam configuration selection criteria, or a separate set of rules). In such examples, at 530, UE 515 may select a codepoint of the set of codepoints indicated in the first DCI message. UE 515 may select the codepoint based on the beam configuration selection criteria as described with reference to FIGS. 3-4. UE 515 may select a default uplink beam associated with the selected codepoint, and may transmit the uplink message using the selected default uplink beam.

In some examples, UE 515 may determine that the first DCI message is a most recent DCI message based on determining whether a time period (e.g., a threshold timing gap) satisfies a threshold timing gap. The threshold timing gap may refer to a beam application time. At 540, UE 515 may determine whether a time period between receiving the first DCI message and the second DCI message satisfies (e.g., is no greater than) the threshold timing gap. If a duration between a previously received DCI message does not satisfy the threshold timing gap (e.g., is less than the threshold timing gap duration), then UE 515 may determine that such a DCI message is not a most recently received DCI message (e.g., may not attempt to utilize TCI state codepoints indicated in the previously received DCI message). However, if the time period between receiving the first DCI message and the second DCI message does satisfy the threshold timing gap, UE 515 may utilize the TCI state codepoints indicated in the first DCI message to determine the default uplink beam for transmitting the uplink message indicated in the second DCI message. In some examples, the first DCI message, or the second DCI message, or both, may be a GC DCI message.

UE 515 may determine the threshold timing gap by comparing two time values or time offsets (e.g., determine which has a greater duration). UE 515 may select the greater of the two time offsets. In some examples, base station 505 may transmit an indication of the threshold timing gap at 520. The indication of the threshold timing gap may be a DCI message, a MAC-CE, an RRC message, or any combination thereof.

In some examples, base station 505 may indicate the beam configuration selection criteria to UE 515 (e.g., at 510). The beam configuration selection criteria may be included in a DCI message, a higher layer signal message (e.g., an RRC information element (IE), a MAC-CE, or the like). The beam configuration selection criteria may be preconfigured at UE 515, included in one or more standards documents, or the like.

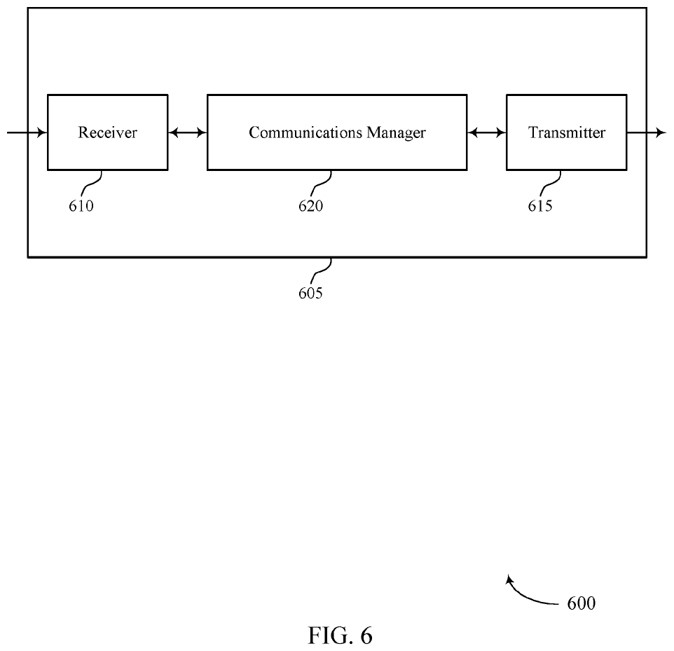

FIG. 6 shows a block diagram 600 of a device 605 that supports default beam configuration selection for uplink transmissions in accordance with aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to default beam configuration selection for uplink transmissions). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to default beam configuration selection for uplink transmissions). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of default beam configuration selection for uplink transmissions as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 620 may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communications at a UE in accordance with examples as disclosed herein. For example, the communications manager 620 may be configured as or otherwise support a means for receiving, from a base station, downlink control information including an uplink grant for a physical uplink shared channel, the downlink control information indicating a set of codepoints corresponding to a set of beam configurations. The communications manager 620 may be configured as or otherwise support a means for selecting a codepoint from the set of codepoints corresponding to a default uplink beam for transmitting an uplink message on the physical uplink shared channel based on a beam configuration selection criteria that indicates criteria for selecting a subset of valid beam configurations from the set of beam configurations. The communications manager 620 may be configured as or otherwise support a means for transmitting the uplink message on the physical uplink shared channel in accordance with the uplink grant using the default uplink beam.

By including or configuring the communications manager 620 in accordance with examples as described herein, the device 605 (e.g., a processor controlling or otherwise coupled to the receiver 610, the transmitter 615, the communications manager 620, or a combination thereof) may support techniques for selecting a default uplink beam, which may result in decreased system latency, more efficient use of available resources, more efficient communication, more efficient use of computational resources, increased battery life, and improved user experience.

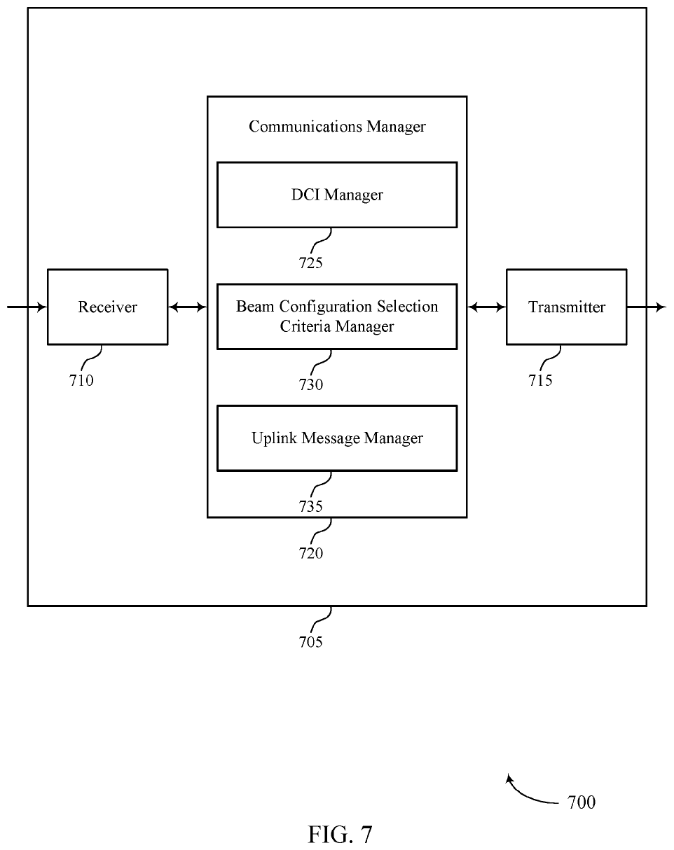

FIG. 7 shows a block diagram 700 of a device 705 that supports default beam configuration selection for uplink transmissions in accordance with aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to default beam configuration selection for uplink transmissions). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to default beam configuration selection for uplink transmissions). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of default beam configuration selection for uplink transmissions as described herein. For example, the communications manager 720 may include a DCI manager 725, a beam configuration selection criteria manager 730, an uplink message manager 735, or any combination thereof. The communications manager 720 may be an example of aspects of a communications manager 620 as described herein. In some examples, the communications manager 720, or various components thereof, may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communications at a UE in accordance with examples as disclosed herein. The DCI manager 725 may be configured as or otherwise support a means for receiving, from a base station, downlink control information including an uplink grant for a physical uplink shared channel, the downlink control information indicating a set of codepoints corresponding to a set of beam configurations. The beam configuration selection criteria manager 730 may be configured as or otherwise support a means for selecting a codepoint from the set of codepoints corresponding to a default uplink beam for transmitting an uplink message on the physical uplink shared channel based on a beam configuration selection criteria that indicates criteria for selecting a subset of valid beam configurations from the set of beam configurations. The uplink message manager 735 may be configured as or otherwise support a means for transmitting the uplink message on the physical uplink shared channel in accordance with the uplink grant using the default uplink beam.

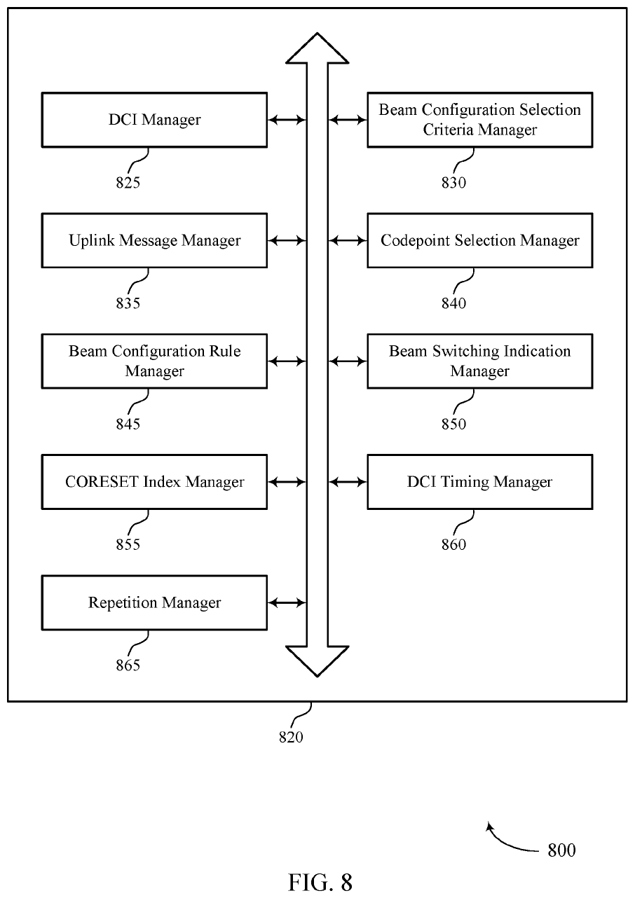

FIG. 8 shows a block diagram 800 of a communications manager 820 that supports default beam configuration selection for uplink transmissions in accordance with aspects of the present disclosure. The communications manager 820 may be an example of aspects of a communications manager 620, a communications manager 720, or both, as described herein. The communications manager 820, or various components thereof, may be an example of means for performing various aspects of default beam configuration selection for uplink transmissions as described herein. For example, the communications manager 820 may include a DCI manager 825, a beam configuration selection criteria manager 830, an uplink message manager 835, a codepoint selection manager 840, a beam configuration rule manager 845, a beam switching indication manager 850, a CORESET index manager 855, a DCI timing manager 860, a repetition manager 865, or any combination thereof. Each of these components may communicate, directly or indirectly, with one another (e.g., via one or more buses).

The communications manager 820 may support wireless communications at a UE in accordance with examples as disclosed herein. The DCI manager 825 may be configured as or otherwise support a means for receiving, from a base station, downlink control information including an uplink grant for a physical uplink shared channel, the downlink control information indicating a set of codepoints corresponding to a set of beam configurations. The beam configuration selection criteria manager 830 may be configured as or otherwise support a means for selecting a codepoint from the set of codepoints corresponding to a default uplink beam for transmitting an uplink message on the physical uplink shared channel based on a beam configuration selection criteria that indicates criteria for selecting a subset of valid beam configurations from the set of beam configurations. The uplink message manager 835 may be configured as or otherwise support a means for transmitting the uplink message on the physical uplink shared channel in accordance with the uplink grant using the default uplink beam.

In some examples, the codepoint selection manager 840 may be configured as or otherwise support a means for comparing codepoint identifiers for codepoints corresponding to the subset of valid beam configurations, where selecting the codepoint from the set of codepoints is based on an ordering of the compared codepoint identifiers.

In some examples, the beam configuration selection criteria manager 830 may be configured as or otherwise support a means for selecting, based on the beam configuration selection criteria, the subset of valid beam configurations, where the beam configuration selection criteria includes a restriction of the subset of valid beam configurations to beam configurations having a single uplink beam option.

In some examples, the beam configuration selection criteria manager 830 may be configured as or otherwise support a means for selecting, based on the beam configuration selection criteria, the subset of valid beam configurations, where the beam configuration selection criteria includes a restriction of the subset of valid beam configurations to beam configurations having a single uplink beam option, multiple uplink beam options, or both.

In some examples, the beam configuration rule manager 845 may be configured as or otherwise support a means for applying a rule indicated in the beam configuration selection criteria, the rule including an indication of which of the multiple uplink beam options to select for transmitting the uplink message, where selecting the codepoint from the set of codepoints is based on applying the rule.

In some examples, the codepoint selection manager 840 may be configured as or otherwise support a means for selecting, based on the beam configuration selection criteria, a second codepoint from the set of codepoints corresponding to a second default uplink beam of the subset of valid beam configurations.

In some examples, to support transmitting the uplink message, the repetition manager 865 may be configured as or otherwise support a means for transmitting a first repetition of the uplink message using the default uplink beam. In some examples, to support transmitting the uplink message, the repetition manager 865 may be configured as or otherwise support a means for transmitting a second repetition of the uplink message using the second default uplink beam.

In some examples, the beam switching indication manager 850 may be configured as or otherwise support a means for receiving, in the downlink control information, a beam switching indication indicating which of the multiple uplink beam options to select for transmitting the uplink message, where selecting the codepoint from the set of codepoints is based on receiving the beam switching indication.

In some examples, to support receiving the downlink control information, the DCI manager 825 may be configured as or otherwise support a means for receiving a first downlink control information message including the uplink grant for the physical uplink shared channel. In some examples, to support receiving the downlink control information, the DCI manager 825 may be configured as or otherwise support a means for receiving, prior to receiving the first downlink control information message, a second downlink control information message including the set of codepoints.

In some examples, the CORESET index manager 855 may be configured as or otherwise support a means for comparing a first control resource set pool index associated with the first downlink control information message with a second control resource set pool index associated with the second downlink control information message. In some examples, the CORESET index manager 855 may be configured as or otherwise support a means for determining, based on the comparing, that the first control resource set pool index and the second control resource set pool index are the same, where selecting the codepoint is based on the first control resource set pool index and the second control resource set pool index being the same.

In some examples, the DCI timing manager 860 may be configured as or otherwise support a means for determining that a time period between receiving the second downlink control information message and receiving the first downlink control information message satisfies a threshold timing gap, where selecting the codepoint is based on the determining.

In some examples, at least one of the first downlink control information message or the second downlink control information message includes a group-common downlink control information message.

In some examples, the DCI timing manager 860 may be configured as or otherwise support a means for receiving, from the base station, an indication of the threshold timing gap, where determining that the time period satisfies the threshold timing gap is based on receiving the indication of the threshold timing gap.

In some examples, the DCI timing manager 860 may be configured as or otherwise support a means for comparing a first time offset value with a second time offset value. In some examples, the DCI timing manager 860 may be configured as or otherwise support a means for selecting the first time offset value based on the comparing, where the first time offset value includes the threshold timing gap and where determining that the time period satisfies the threshold timing gap is based on selecting the first time offset value.

In some examples, the beam configuration selection criteria manager 830 may be configured as or otherwise support a means for receiving, from the base station, an indication of the beam configuration selection criteria, where selecting the codepoint is based on receiving the indication of the beam configuration selection criteria.

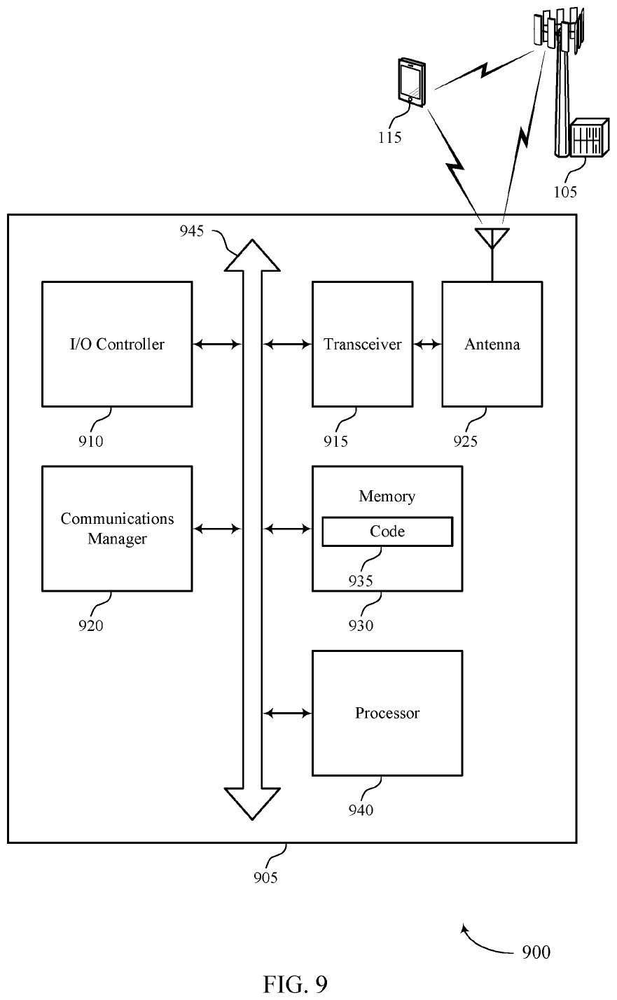

FIG. 9 shows a diagram of a system 900 including a device 905 that supports default beam configuration selection for uplink transmissions in accordance with aspects of the present disclosure. The device 905 may be an example of or include the components of a device 605, a device 705, or a UE 115 as described herein. The device 905 may communicate wirelessly with one or more base stations 105, UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting default beam configuration selection for uplink transmissions). For example, the device 905 or a component of the device 905 may include a processor 940 and memory 930 coupled to the processor 940, the processor 940 and memory 930 configured to perform various functions described herein.

The communications manager 920 may support wireless communications at a UE in accordance with examples as disclosed herein. For example, the communications manager 920 may be configured as or otherwise support a means for receiving, from a base station, downlink control information including an uplink grant for a physical uplink shared channel, the downlink control information indicating a set of codepoints corresponding to a set of beam configurations. The communications manager 920 may be configured as or otherwise support a means for selecting a codepoint from the set of codepoints corresponding to a default uplink beam for transmitting an uplink message on the physical uplink shared channel based on a beam configuration selection criteria that indicates criteria for selecting a subset of valid beam configurations from the set of beam configurations. The communications manager 920 may be configured as or otherwise support a means for transmitting the uplink message on the physical uplink shared channel in accordance with the uplink grant using the default uplink beam.

By including or configuring the communications manager 920 in accordance with examples as described herein, the device 905 may support techniques for selecting a default uplink beam, which may result in decreased system latency, more efficient use of available resources, more efficient communication, more efficient use of computational resources, increased battery life, and improved user experience.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of default beam configuration selection for uplink transmissions as described herein, or the processor 940 and the memory 930 may be otherwise configured to perform or support such operations.

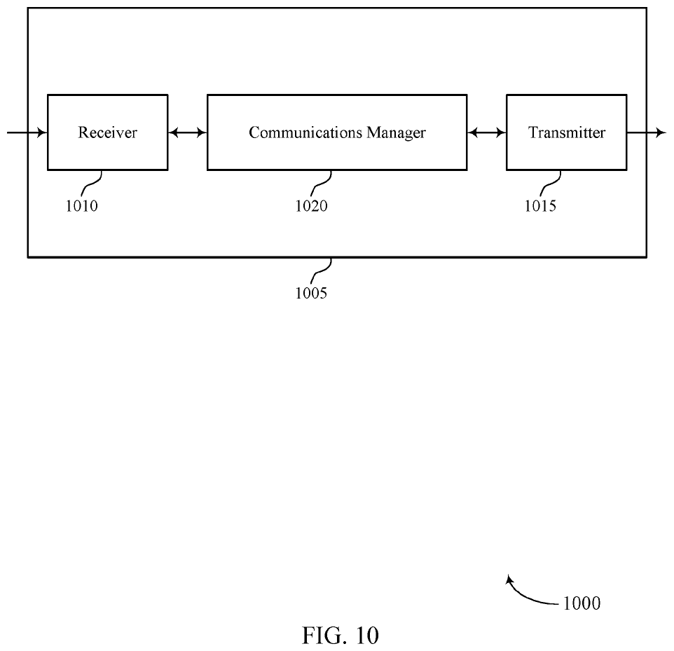

FIG. 10 shows a block diagram 1000 of a device 1005 that supports default beam configuration selection for uplink transmissions in accordance with aspects of the present disclosure. The device 1005 may be an example of aspects of a base station 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to default beam configuration selection for uplink transmissions). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to default beam configuration selection for uplink transmissions). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of default beam configuration selection for uplink transmissions as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1020 may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communications at a base station in accordance with examples as disclosed herein. For example, the communications manager 1020 may be configured as or otherwise support a means for transmitting, to a UE, a downlink control information including an uplink grant for a physical uplink shared channel, the downlink control information indicating a set of codepoints corresponding to a set of beam configurations. The communications manager 1020 may be configured as or otherwise support a means for selecting a default uplink beam for receiving an uplink message on the physical uplink shared channel based on a beam configuration selection criteria that indicates criteria for selecting a subset of valid beam configurations from the set of beam configurations. The communications manager 1020 may be configured as or otherwise support a means for receiving the uplink message on the physical uplink shared channel in accordance with the uplink grant using the default uplink beam.

By including or configuring the communications manager 1020 in accordance with examples as described herein, the device 1005 (e.g., a processor controlling or otherwise coupled to the receiver 1010, the transmitter 1015, the communications manager 1020, or a combination thereof) may support techniques for selecting a default uplink beam, which may result in decreased system latency, more efficient use of available resources, more efficient communication, more efficient use of computational resources, increased battery life, and improved user experience.

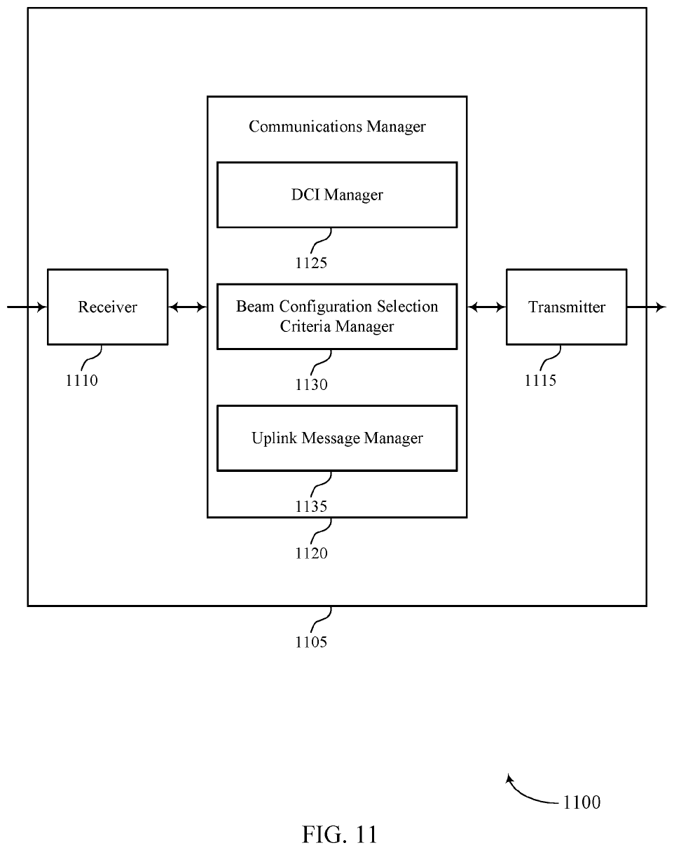

FIG. 11 shows a block diagram 1100 of a device 1105 that supports default beam configuration selection for uplink transmissions in accordance with aspects of the present disclosure. The device 1105 may be an example of aspects of a device 1005 or a base station 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to default beam configuration selection for uplink transmissions). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to default beam configuration selection for uplink transmissions). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of default beam configuration selection for uplink transmissions as described herein. For example, the communications manager 1120 may include a DCI manager 1125, a beam configuration selection criteria manager 1130, an uplink message manager 1135, or any combination thereof. The communications manager 1120 may be an example of aspects of a communications manager 1020 as described herein. In some examples, the communications manager 1120, or various components thereof, may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communications at a base station in accordance with examples as disclosed herein. The DCI manager 1125 may be configured as or otherwise support a means for transmitting, to a UE, a downlink control information including an uplink grant for a physical uplink shared channel, the downlink control information indicating a set of codepoints corresponding to a set of beam configurations. The beam configuration selection criteria manager 1130 may be configured as or otherwise support a means for selecting a default uplink beam for receiving an uplink message on the physical uplink shared channel based on a beam configuration selection criteria that indicates criteria for selecting a subset of valid beam configurations from the set of beam configurations. The uplink message manager 1135 may be configured as or otherwise support a means for receiving the uplink message on the physical uplink shared channel in accordance with the uplink grant using the default uplink beam.

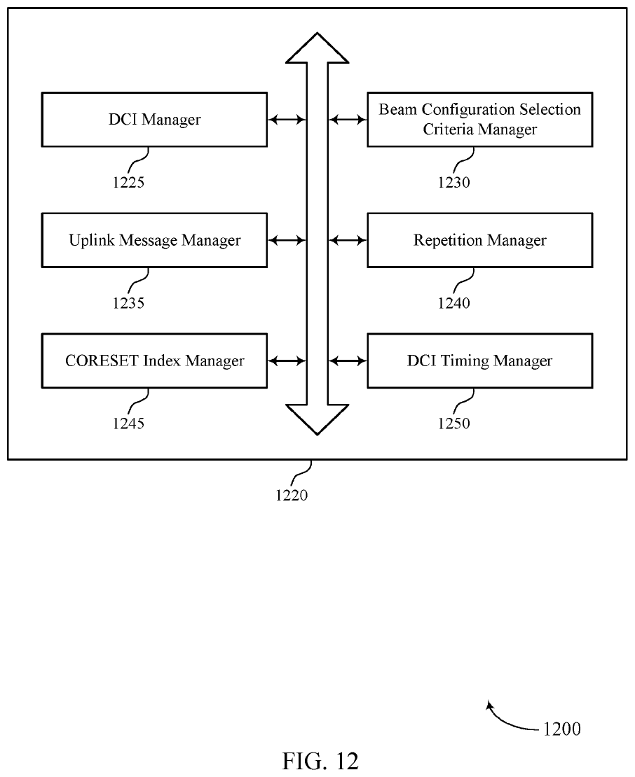

FIG. 12 shows a block diagram 1200 of a communications manager 1220 that supports default beam configuration selection for uplink transmissions in accordance with aspects of the present disclosure. The communications manager 1220 may be an example of aspects of a communications manager 1020, a communications manager 1120, or both, as described herein. The communications manager 1220, or various components thereof, may be an example of means for performing various aspects of default beam configuration selection for uplink transmissions as described herein. For example, the communications manager 1220 may include a DCI manager 1225, a beam configuration selection criteria manager 1230, an uplink message manager 1235, a repetition manager 1240, a CORESET index manager 1245, a DCI timing manager 1250, or any combination thereof. Each of these components may communicate, directly or indirectly, with one another (e.g., via one or more buses).

The communications manager 1220 may support wireless communications at a base station in accordance with examples as disclosed herein. The DCI manager 1225 may be configured as or otherwise support a means for transmitting, to a UE, a downlink control information including an uplink grant for a physical uplink shared channel, the downlink control information indicating a set of codepoints corresponding to a set of beam configurations. The beam configuration selection criteria manager 1230 may be configured as or otherwise support a means for selecting a default uplink beam for receiving an uplink message on the physical uplink shared channel based on a beam configuration selection criteria that indicates criteria for selecting a subset of valid beam configurations from the set of beam configurations. The uplink message manager 1235 may be configured as or otherwise support a means for receiving the uplink message on the physical uplink shared channel in accordance with the uplink grant using the default uplink beam.

In some examples, the beam configuration selection criteria includes a restriction of the subset of valid beam configurations to beam configurations having a single uplink beam option.

In some examples, the beam configuration selection criteria includes a restriction of the subset of valid beam configurations to beam configurations having a single uplink beam option, multiple uplink beam options, or both.

In some examples, to support receiving the uplink message, the repetition manager 1240 may be configured as or otherwise support a means for receiving a first repetition of the uplink message using the default uplink beam associated with a first uplink beam option of the multiple uplink beam options. In some examples, to support receiving the uplink message, the repetition manager 1240 may be configured as or otherwise support a means for receiving a second repetition of the uplink message using a second default uplink beam associated with a second uplink beam option of the multiple uplink beam options.

In some examples, to support transmitting the downlink control information, the DCI manager 1225 may be configured as or otherwise support a means for transmitting a first downlink control information message including the uplink grant for the physical uplink shared channel. In some examples, to support transmitting the downlink control information, the DCI manager 1225 may be configured as or otherwise support a means for transmitting, prior to transmitting the first downlink control information message, a second downlink control information message including a the set of codepoints.

In some examples, the CORESET index manager 1245 may be configured as or otherwise support a means for receiving the uplink message on the default uplink beam is based on a first control resource set pool index associated with the first downlink control information message being the same as a second control resource set pool index associated with the second downlink control information message.

In some examples, the DCI timing manager 1250 may be configured as or otherwise support a means for receiving the uplink message on the default uplink beam is based on a time period between transmitting the second downlink control information message and transmitting the first downlink control information message satisfies a threshold timing gap.

In some examples, the beam configuration selection criteria manager 1230 may be configured as or otherwise support a means for transmitting, to the UE, an indication of the beam configuration selection criteria, where receiving the uplink message on the default uplink beam is based on transmitting the indication of the beam configuration selection criteria.

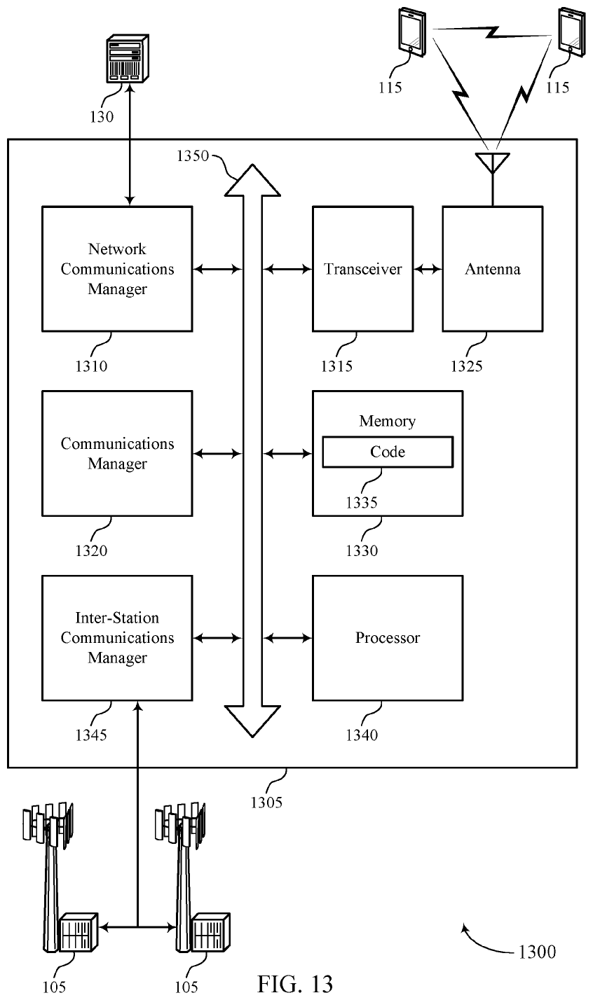

FIG. 13 shows a diagram of a system 1300 including a device 1305 that supports default beam configuration selection for uplink transmissions in accordance with aspects of the present disclosure. The device 1305 may be an example of or include the components of a device 1005, a device 1105, or a base station 105 as described herein. The device 1305 may communicate wirelessly with one or more base stations 105, UEs 115, or any combination thereof. The device 1305 may include components for bi-directional voice and data communications including components for transmitting and receiving communications, such as a communications manager 1320, a network communications manager 1310, a transceiver 1315, an antenna 1325, a memory 1330, code 1335, a processor 1340, and an inter-station communications manager 1345. These components may be in electronic communication or otherwise coupled (e.g., operatively, communicatively, functionally, electronically, electrically) via one or more buses (e.g., a bus 1350).

The network communications manager 1310 may manage communications with a core network 130 (e.g., via one or more wired backhaul links). For example, the network communications manager 1310 may manage the transfer of data communications for client devices, such as one or more UEs 115.

In some cases, the device 1305 may include a single antenna 1325. However, in some other cases the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include RAM and ROM. The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a BIOS which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting default beam configuration selection for uplink transmissions). For example, the device 1305 or a component of the device 1305 may include a processor 1340 and memory 1330 coupled to the processor 1340, the processor 1340 and memory 1330 configured to perform various functions described herein.

The inter-station communications manager 1345 may manage communications with other base stations 105, and may include a controller or scheduler for controlling communications with UEs 115 in cooperation with other base stations 105. For example, the inter-station communications manager 1345 may coordinate scheduling for transmissions to UEs 115 for various interference mitigation techniques such as beamforming or joint transmission. In some examples, the inter-station communications manager 1345 may provide an X2 interface within an LTE/LTE-A wireless communications network technology to provide communication between base stations 105.

The communications manager 1320 may support wireless communications at a base station in accordance with examples as disclosed herein. For example, the communications manager 1320 may be configured as or otherwise support a means for transmitting, to a UE, a downlink control information including an uplink grant for a physical uplink shared channel, the downlink control information indicating a set of codepoints corresponding to a set of beam configurations. The communications manager 1320 may be configured as or otherwise support a means for selecting a default uplink beam for receiving an uplink message on the physical uplink shared channel based on a beam configuration selection criteria that indicates criteria for selecting a subset of valid beam configurations from the set of beam configurations. The communications manager 1320 may be configured as or otherwise support a means for receiving the uplink message on the physical uplink shared channel in accordance with the uplink grant using the default uplink beam.

By including or configuring the communications manager 1320 in accordance with examples as described herein, the device 1305 may support techniques for selecting a default uplink beam, which may result in decreased system latency, more efficient use of available resources, more efficient communication, more efficient use of computational resources, increased battery life, and improved user experience.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of default beam configuration selection for uplink transmissions as described herein, or the processor 1340 and the memory 1330 may be otherwise configured to perform or support such operations.

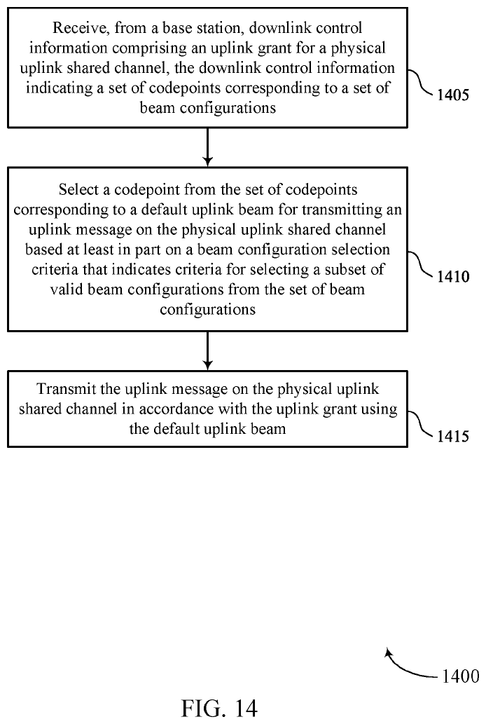

FIG. 14 shows a flowchart illustrating a method 1400 that supports default beam configuration selection for uplink transmissions in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving, from a base station, downlink control information including an uplink grant for a physical uplink shared channel, the downlink control information indicating a set of codepoints corresponding to a set of beam configurations. The operations of 1405 may be performed in accordance with examples as disclosed herein. In some examples, aspects of the operations of 1405 may be performed by a DCI manager 825 as described with reference to FIG. 8.

At 1410, the method may include selecting a codepoint from the set of codepoints corresponding to a default uplink beam for transmitting an uplink message on the physical uplink shared channel based on a beam configuration selection criteria that indicates criteria for selecting a subset of valid beam configurations from the set of beam configurations. The operations of 1410 may be performed in accordance with examples as disclosed herein. In some examples, aspects of the operations of 1410 may be performed by a beam configuration selection criteria manager 830 as described with reference to FIG. 8.

At 1415, the method may include transmitting the uplink message on the physical uplink shared channel in accordance with the uplink grant using the default uplink beam. The operations of 1415 may be performed in accordance with examples as disclosed herein. In some examples, aspects of the operations of 1415 may be performed by an uplink message manager 835 as described with reference to FIG. 8.

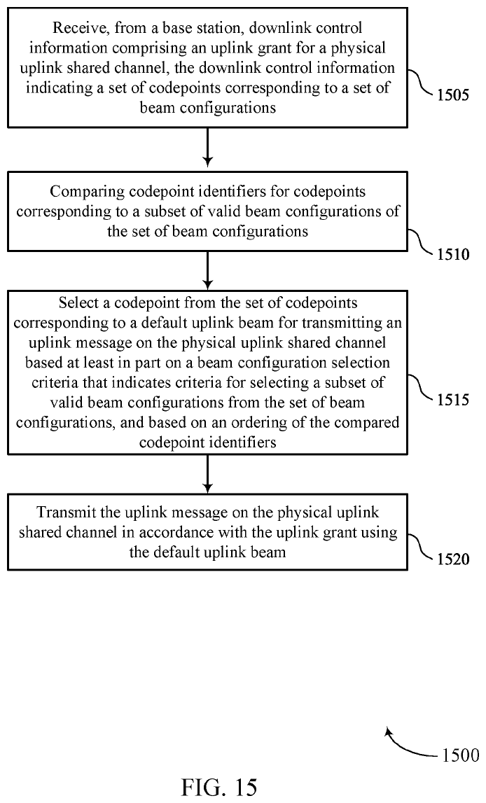

FIG. 15 shows a flowchart illustrating a method 1500 that supports default beam configuration selection for uplink transmissions in accordance with aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving, from a base station, downlink control information including an uplink grant for a physical uplink shared channel, the downlink control information indicating a set of codepoints corresponding to a set of beam configurations. The operations of 1505 may be performed in accordance with examples as disclosed herein. In some examples, aspects of the operations of 1505 may be performed by a DCI manager 825 as described with reference to FIG. 8.

At 1510, the method may include comparing codepoint identifiers for codepoints corresponding to a subset of valid beam configurations. The operations of 1510 may be performed in accordance with examples as disclosed herein. In some examples, aspects of the operations of 1510 may be performed by a codepoint selection manager 840 as described with reference to FIG. 8.

At 1515, the method may include selecting a codepoint from the set of codepoints corresponding to a default uplink beam for transmitting an uplink message on the physical uplink shared channel based on a beam configuration selection criteria that indicates criteria for selecting a subset of valid beam configurations from the set of beam configurations, and based on an ordering of the compared codepoint identifiers. The operations of 1515 may be performed in accordance with examples as disclosed herein. In some examples, aspects of the operations of 1515 may be performed by a beam configuration selection criteria manager 830 as described with reference to FIG. 8.

At 1520, the method may include transmitting the uplink message on the physical uplink shared channel in accordance with the uplink grant using the default uplink beam. The operations of 1520 may be performed in accordance with examples as disclosed herein. In some examples, aspects of the operations of 1520 may be performed by an uplink message manager 835 as described with reference to FIG. 8.

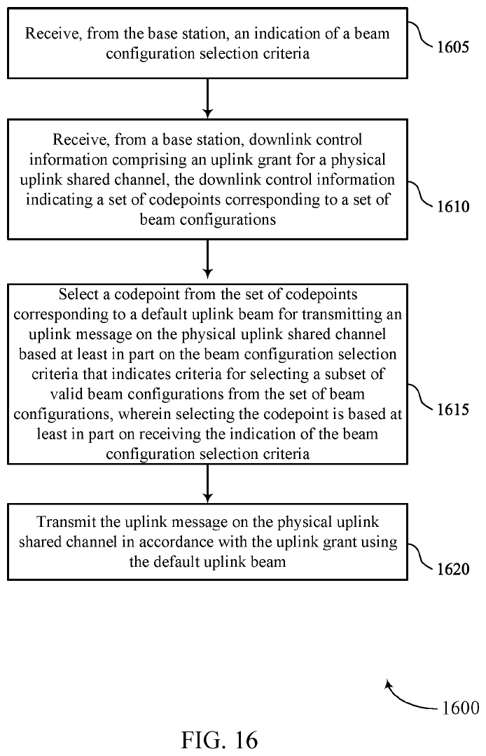

FIG. 16 shows a flowchart illustrating a method 1600 that supports default beam configuration selection for uplink transmissions in accordance with aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include receiving, from the base station, an indication of a beam configuration selection criteria. The operations of 1605 may be performed in accordance with examples as disclosed herein. In some examples, aspects of the operations of 1605 may be performed by a beam configuration selection criteria manager 830 as described with reference to FIG. 8.

At 1610, the method may include receiving, from a base station, downlink control information including an uplink grant for a physical uplink shared channel, the downlink control information indicating a set of codepoints corresponding to a set of beam configurations. The operations of 1610 may be performed in accordance with examples as disclosed herein. In some examples, aspects of the operations of 1610 may be performed by a DCI manager 825 as described with reference to FIG. 8.

At 1615, the method may include selecting a codepoint from the set of codepoints corresponding to a default uplink beam for transmitting an uplink message on the physical uplink shared channel based at least in part on the beam configuration selection criteria that indicates criteria for selecting a subset of valid beam configurations from the set of beam configurations, wherein selecting the codepoint is based at least in part on receiving the indication of the beam configuration selection criteria. The operations of 1615 may be performed in accordance with examples as disclosed herein. In some examples, aspects of the operations of 1615 may be performed by a beam configuration selection criteria manager 830 as described with reference to FIG. 8.

At 1620, the method may include transmitting the uplink message on the physical uplink shared channel in accordance with the uplink grant using the default uplink beam. The operations of 1620 may be performed in accordance with examples as disclosed herein. In some examples, aspects of the operations of 1620 may be performed by an uplink message manager 835 as described with reference to FIG. 8.

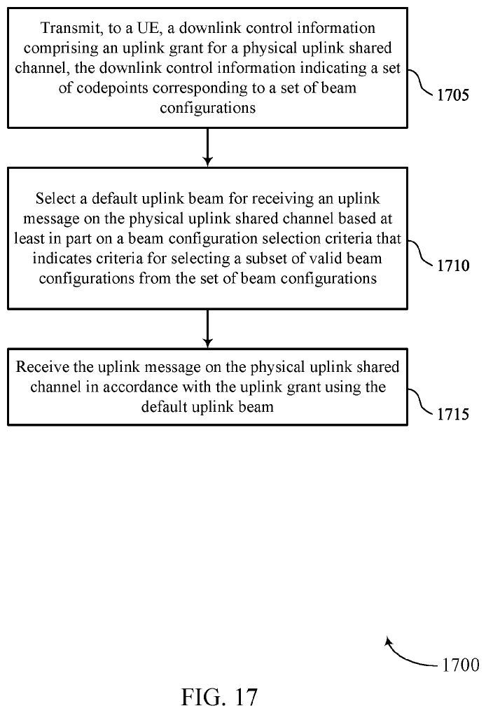

FIG. 17 shows a flowchart illustrating a method 1700 that supports default beam configuration selection for uplink transmissions in accordance with aspects of the present disclosure. The operations of the method 1700 may be implemented by a base station or its components as described herein. For example, the operations of the method 1700 may be performed by a base station 105 as described with reference to FIGS. 1 through 5 and 10 through 13. In some examples, a base station may execute a set of instructions to control the functional elements of the base station to perform the described functions. Additionally, or alternatively, the base station may perform aspects of the described functions using special-purpose hardware.

At 1705, the method may include transmitting, to a UE, a downlink control information including an uplink grant for a physical uplink shared channel, the downlink control information indicating a set of codepoints corresponding to a set of beam configurations. The operations of 1705 may be performed in accordance with examples as disclosed herein. In some examples, aspects of the operations of 1705 may be performed by a DCI manager 1225 as described with reference to FIG. 12.

At 1710, the method may include selecting a default uplink beam for receiving an uplink message on the physical uplink shared channel based on a beam configuration selection criteria that indicates criteria for selecting a subset of valid beam configurations from the set of beam configurations. The operations of 1710 may be performed in accordance with examples as disclosed herein. In some examples, aspects of the operations of 1710 may be performed by a beam configuration selection criteria manager 1230 as described with reference to FIG. 12.

At 1715, the method may include receiving the uplink message on the physical uplink shared channel in accordance with the uplink grant using the default uplink beam. The operations of 1715 may be performed in accordance with examples as disclosed herein. In some examples, aspects of the operations of 1715 may be performed by an uplink message manager 1235 as described with reference to FIG. 12.

Aspect 1: A method for wireless communications at a UE, comprising: receiving, from a base station, downlink control information comprising an uplink grant for a physical uplink shared channel, the downlink control information indicating a set of codepoints corresponding to a set of beam configurations; selecting a codepoint from the set of codepoints corresponding to a default uplink beam for transmitting an uplink message on the physical uplink shared channel based at least in part on a beam configuration selection criteria that indicates criteria for selecting a subset of valid beam configurations from the set of beam configurations; and transmitting the uplink message on the physical uplink shared channel in accordance with the uplink grant using the default uplink beam.

Aspect 2: The method of aspect 1, further comprising: comparing codepoint identifiers for codepoints corresponding to the subset of valid beam configurations, wherein selecting the codepoint from the set of codepoints is based at least in part on an ordering of the compared codepoint identifiers.

Aspect 3: The method of any of aspects 1 through 2, further comprising: selecting, based at least in part on the beam configuration selection criteria, the subset of valid beam configurations, wherein the beam configuration selection criteria comprises a restriction of the subset of valid beam configurations to beam configurations having a single uplink beam option.

Aspect 4: The method of any of aspects 1 through 3, further comprising: selecting, based at least in part on the beam configuration selection criteria, the subset of valid beam configurations, wherein the beam configuration selection criteria comprises a restriction of the subset of valid beam configurations to beam configurations having a single uplink beam option, multiple uplink beam options, or both.

Aspect 5: The method of aspect 4, further comprising: applying a rule indicated in the beam configuration selection criteria, the rule comprising an indication of which of the multiple uplink beam options to select for transmitting the uplink message, wherein selecting the codepoint from the set of codepoints is based at least in part on applying the rule.

Aspect 6: The method of any of aspects 4 through 5, further comprising: selecting, based at least in part on the beam configuration selection criteria, a second codepoint from the set of codepoints corresponding to a second default uplink beam of the subset of valid beam configurations.

Aspect 7: The method of aspect 6, wherein transmitting the uplink message comprises: transmitting a first repetition of the uplink message using the default uplink beam; and transmitting a second repetition of the uplink message using the second default uplink beam.

Aspect 8: The method of any of aspects 4 through 7, further comprising: receiving, in the downlink control information, a beam switching indication indicating which of the multiple uplink beam options to select for transmitting the uplink message, wherein selecting the codepoint from the set of codepoints is based at least in part on receiving the beam switching indication.

Aspect 9: The method of any of aspects 1 through 8, wherein receiving the downlink control information comprises: receiving a first downlink control information message comprising the uplink grant for the physical uplink shared channel; and receiving, prior to receiving the first downlink control information message, a second downlink control information message comprising the set of codepoints.

Aspect 10: The method of aspect 9, further comprising: comparing a first control resource set pool index associated with the first downlink control information message with a second control resource set pool index associated with the second downlink control information message; and determining, based at least in part on the comparing, that the first control resource set pool index and the second control resource set pool index are the same, wherein selecting the codepoint is based at least in part on the first control resource set pool index and the second control resource set pool index being the same.

Aspect 11: The method of any of aspects 9 through 10, further comprising: determining that a time period between receiving the second downlink control information message and receiving the first downlink control information message satisfies a threshold timing gap, wherein selecting the codepoint is based at least in part on the determining.

Aspect 12: The method of aspect 11, wherein at least one of the first downlink control information message or the second downlink control information message comprises a group-common downlink control information message.

Aspect 13: The method of any of aspects 11 through 12, further comprising: receiving, from the base station, an indication of the threshold timing gap, wherein determining that the time period satisfies the threshold timing gap is based at least in part on receiving the indication of the threshold timing gap.

Aspect 14: The method of any of aspects 11 through 13, further comprising: comparing a first time offset value with a second time offset value; and selecting the first time offset value based at least in part on the comparing, wherein the first time offset value comprises the threshold timing gap and wherein determining that the time period satisfies the threshold timing gap is based at least in part on selecting the first time offset value.

Aspect 15: The method of any of aspects 1 through 14, further comprising: receiving, from the base station, an indication of the beam configuration selection criteria, wherein selecting the codepoint is based at least in part on receiving the indication of the beam configuration selection criteria.

Aspect 16: A method for wireless communications at a base station, comprising: transmitting, to a UE, a downlink control information comprising an uplink grant for a physical uplink shared channel, the downlink control information indicating a set of codepoints corresponding to a set of beam configurations; selecting a default uplink beam for receiving an uplink message on the physical uplink shared channel based at least in part on a beam configuration selection criteria that indicates criteria for selecting a subset of valid beam configurations from the set of beam configurations; and receiving the uplink message on the physical uplink shared channel in accordance with the uplink grant using the default uplink beam.

Aspect 17: The method of aspect 16, wherein the beam configuration selection criteria comprises a restriction of the subset of valid beam configurations to beam configurations having a single uplink beam option.

Aspect 18: The method of any of aspects 16 through 17, wherein the beam configuration selection criteria comprises a restriction of the subset of valid beam configurations to beam configurations having a single uplink beam option, multiple uplink beam options, or both.

Aspect 19: The method of aspect 18, wherein receiving the uplink message further comprises: receiving a first repetition of the uplink message using the default uplink beam associated with a first uplink beam option of the multiple uplink beam options; and receiving a second repetition of the uplink message using a second default uplink beam associated with a second uplink beam option of the multiple uplink beam options.

Aspect 20: The method of any of aspects 16 through 19, wherein transmitting the downlink control information comprises: transmitting a first downlink control information message comprising the uplink grant for the physical uplink shared channel; and transmitting, prior to transmitting the first downlink control information message, a second downlink control information message comprising a the set of codepoints.

Aspect 21: The method of aspect 20, further comprising: receiving the uplink message on the default uplink beam is based at least in part on a first control resource set pool index associated with the first downlink control information message being the same as a second control resource set pool index associated with the second downlink control information message.

Aspect 22: The method of any of aspects 20 through 21, further comprising: receiving the uplink message on the default uplink beam is based at least in part on a time period between transmitting the second downlink control information message and transmitting the first downlink control information message satisfies a threshold timing gap.

Aspect 23: The method of any of aspects 16 through 22, further comprising: transmitting, to the UE, an indication of the beam configuration selection criteria, wherein receiving the uplink message on the default uplink beam is based at least in part on transmitting the indication of the beam configuration selection criteria.

Aspect 24: An apparatus for wireless communications at a UE, comprising a processor; memory coupled with the processor; and instructions stored in the memory and executable by the processor to cause the apparatus to perform a method of any of aspects 1 through 15.

Aspect 25: An apparatus for wireless communications at a UE, comprising at least one means for performing a method of any of aspects 1 through 15.

Aspect 26: A non-transitory computer-readable medium storing code for wireless communications at a UE, the code comprising instructions executable by a processor to perform a method of any of aspects 1 through 15.

Aspect 27: An apparatus for wireless communications at a base station, comprising a processor; memory coupled with the processor; and instructions stored in the memory and executable by the processor to cause the apparatus to perform a method of any of aspects 16 through 23.

Aspect 28: An apparatus for wireless communications at a base station, comprising at least one means for performing a method of any of aspects 16 through 23.

Aspect 29: A non-transitory computer-readable medium storing code for wireless communications at a base station, the code comprising instructions executable by a processor to perform a method of any of aspects 16 through 23.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
receiving, from a base station, downlink control information comprising an uplink grant for a physical uplink shared channel, the downlink control information indicating a set of codepoints corresponding to a set of beam configurations;
selecting a codepoint from the set of codepoints corresponding to a default uplink beam for transmitting an uplink message on the physical uplink shared channel based at least in part on a beam configuration selection criteria that indicates criteria for selecting a subset of valid beam configurations from the set of beam configurations; and
transmitting the uplink message on the physical uplink shared channel in accordance with the uplink grant using the default uplink beam.

2. The method of claim 1, further comprising:
comparing codepoint identifiers for codepoints corresponding to the subset of valid beam configurations, wherein selecting the codepoint from the set of codepoints is based at least in part on an ordering of the compared codepoint identifiers.

3. The method of claim 1, further comprising:
selecting, based at least in part on the beam configuration selection criteria, the subset of valid beam configurations, wherein the beam configuration selection criteria comprises a restriction of the subset of valid beam configurations to beam configurations having a single uplink beam option.

4. The method of claim 1, further comprising:
selecting, based at least in part on the beam configuration selection criteria, the subset of valid beam configurations, wherein the beam configuration selection criteria comprises a restriction of the subset of valid beam configurations to beam configurations having a single uplink beam option, multiple uplink beam options, or both.

5. The method of claim 4, further comprising:
applying a rule indicated in the beam configuration selection criteria, the rule comprising an indication of which of the multiple uplink beam options to select for transmitting the uplink message, wherein selecting the codepoint from the set of codepoints is based at least in part on applying the rule.

6. The method of claim 4, further comprising:
selecting, based at least in part on the beam configuration selection criteria, a second codepoint from the set of codepoints corresponding to a second default uplink beam of the subset of valid beam configurations.

7. The method of claim 6, wherein transmitting the uplink message comprises:
transmitting a first repetition of the uplink message using the default uplink beam; and
transmitting a second repetition of the uplink message using the second default uplink beam.

8. The method of claim 4, further comprising:
receiving, in the downlink control information, a beam switching indication indicating which of the multiple uplink beam options to select for transmitting the uplink message, wherein selecting the codepoint from the set of codepoints is based at least in part on receiving the beam switching indication.

9. The method of claim 1, wherein receiving the downlink control information comprises:
receiving a first downlink control information message comprising the uplink grant for the physical uplink shared channel; and
receiving, prior to receiving the first downlink control information message, a second downlink control information message comprising the set of codepoints.

10. The method of claim 9, further comprising:
comparing a first control resource set pool index associated with the first downlink control information message with a second control resource set pool index associated with the second downlink control information message;
determining, based at least in part on the comparing, that the first control resource set pool index and the second control resource set pool index are the same, wherein selecting the codepoint is based at least in part on the first control resource set pool index and the second control resource set pool index being the same.

11. The method of claim 9, further comprising:
determining that a time period between receiving the second downlink control information message and receiving the first downlink control information message satisfies a threshold timing gap, wherein selecting the codepoint is based at least in part on the determining.

12. The method of claim 11, wherein at least one of the first downlink control information message or the second downlink control information message comprises a group-common downlink control information message.

13. The method of claim 11, further comprising:
receiving, from the base station, an indication of the threshold timing gap, wherein determining that the time period satisfies the threshold timing gap is based at least in part on receiving the indication of the threshold timing gap.

14. The method of claim 11, further comprising:
comparing a first time offset value with a second time offset value; and
selecting the first time offset value based at least in part on the comparing, wherein the first time offset value comprises the threshold timing gap and wherein determining that the time period satisfies the threshold timing gap is based at least in part on selecting the first time offset value.

15. The method of claim 1, further comprising:
receiving, from the base station, an indication of the beam configuration selection criteria, wherein selecting the codepoint is based at least in part on receiving the indication of the beam configuration selection criteria.

16. A method for wireless communications at a base station, comprising:
transmitting, to a user equipment (UE), a downlink control information comprising an uplink grant for a physical uplink shared channel, the downlink control information indicating a set of codepoints corresponding to a set of beam configurations;
selecting a default uplink beam for receiving an uplink message on the physical uplink shared channel based at least in part on a beam configuration selection criteria that indicates criteria for selecting a subset of valid beam configurations from the set of beam configurations; and
receiving the uplink message on the physical uplink shared channel in accordance with the uplink grant using the default uplink beam.

17. The method of claim 16, wherein the beam configuration selection criteria comprises a restriction of the subset of valid beam configurations to beam configurations having a single uplink beam option.

18. The method of claim 16, wherein the beam configuration selection criteria comprises a restriction of the subset of valid beam configurations to beam configurations having a single uplink beam option, multiple uplink beam options, or both.

19. The method of claim 18, wherein receiving the uplink message further comprises:
receiving a first repetition of the uplink message using the default uplink beam associated with a first uplink beam option of the multiple uplink beam options; and
receiving a second repetition of the uplink message using a second default uplink beam associated with a second uplink beam option of the multiple uplink beam options.

20. The method of claim 16, wherein transmitting the downlink control information comprises:
transmitting a first downlink control information message comprising the uplink grant for the physical uplink shared channel; and
transmitting, prior to transmitting the first downlink control information message, a second downlink control information message comprising a the set of codepoints.

21. The method of claim 20, further comprising:
receiving the uplink message on the default uplink beam is based at least in part on a first control resource set pool index associated with the first downlink control information message being the same as a second control resource set pool index associated with the second downlink control information message.

22. The method of claim 20, further comprising:
receiving the uplink message on the default uplink beam is based at least in part on a time period between transmitting the second downlink control information message and transmitting the first downlink control information message satisfies a threshold timing gap.

23. The method of claim 16, further comprising:
transmitting, to the UE, an indication of the beam configuration selection criteria, wherein receiving the uplink message on the default uplink beam is based at least in part on transmitting the indication of the beam configuration selection criteria.

24. An apparatus for wireless communications at a user equipment (UE), comprising:
a processor;
memory coupled with the processor; and
instructions stored in the memory and executable by the processor to cause the apparatus to:
receive, from a base station, downlink control information comprising an uplink grant for a physical uplink shared channel, the downlink control information indicating a set of codepoints corresponding to a set of beam configurations;
select a codepoint from the set of codepoints corresponding to a default uplink beam for transmitting an uplink message on the physical uplink shared channel based at least in part on a beam configuration selection criteria that indicates criteria for selecting a subset of valid beam configurations from the set of beam configurations; and
transmit the uplink message on the physical uplink shared channel in accordance with the uplink grant using the default uplink beam.

25. The apparatus of claim 24, wherein the instructions are further executable by the processor to cause the apparatus to:
compare codepoint identifiers for codepoints corresponding to the subset of valid beam configurations, wherein selecting the codepoint from the set of codepoints is based at least in part on an ordering of the compared codepoint identifiers.

26. The apparatus of claim 24, wherein the instructions are further executable by the processor to cause the apparatus to:
select, based at least in part on the beam configuration selection criteria, the subset of valid beam configurations, wherein the beam configuration selection criteria comprises a restriction of the subset of valid beam configurations to beam configurations having a single uplink beam option.

27. The apparatus of claim 24, wherein the instructions are further executable by the processor to cause the apparatus to:
select, based at least in part on the beam configuration selection criteria, the subset of valid beam configurations, wherein the beam configuration selection criteria comprises a restriction of the subset of valid beam configurations to beam configurations having a single uplink beam option, multiple uplink beam options, or both.

28. The apparatus of claim 24, wherein the instructions to receive the downlink control information are executable by the processor to cause the apparatus to:
receive a first downlink control information message comprising the uplink grant for the physical uplink shared channel; and
receive, prior to receiving the first downlink control information message, a second downlink control information message comprising the set of codepoints.

29. The apparatus of claim 24, wherein the instructions are further executable by the processor to cause the apparatus to:
receive, from the base station, an indication of the beam configuration selection criteria, wherein selecting the codepoint is based at least in part on receiving the indication of the beam configuration selection criteria.

30. An apparatus for wireless communications at a base station, comprising:
a processor;
memory coupled with the processor; and
instructions stored in the memory and executable by the processor to cause the apparatus to:
transmit, to a user equipment (UE), a downlink control information comprising an uplink grant for a physical uplink shared channel, the downlink control information indicating a set of codepoints corresponding to a set of beam configurations;
select a default uplink beam for receiving an uplink message on the physical uplink shared channel based at least in part on a beam configuration selection criteria that indicates criteria for selecting a subset of valid beam configurations from the set of beam configurations; and
receive the uplink message on the physical uplink shared channel in accordance with the uplink grant using the default uplink beam.
